(19) United States
(12) Patent Application Publication
(10) Pub. No.: US 2016/0363268 A1
(43) Pub. Date: Dec. 15, 2016

(54) LED LIGHTING APPARATUS

(71) Applicant: Young Wan KIM, Goyang-si (KR)

(72) Inventor: Young Wan KIM, Goyang-si (KR)

(21) Appl. No.: 14/778,073

(22) PCT Filed: Mar. 18, 2014
(86) PCT No.: PCT/KR2014/002291

§ 371 Date: Aug. 18, 2016

(30) Foreign Application Priority Data
Mar. 18, 2013 (KR) 10-2013-0028705
Aug. 21, 2013 (KR) 10-2013-0098918
Dec. 6, 2013 (KR) 10-2013-0151624

(51) Int. Cl. F21K 9/20; F21S 8/10

(52) U.S. Cl. CPC F21K 9/20; F21S 48/328; F21S 48/31; F21S 48/115; F21S 48/215; F21S 48/1109; F21S 48/212; F21S 48/1394; F21S 48/238; F21Y 2115/10

(57) ABSTRACT

Disclosed is an LED lighting apparatus, and more particularly, to an LED lighting apparatus using an LED device. The LED lighting apparatus includes: one or more metallic plates; and one or more LED devices installed on a surface of the metallic plates, wherein only one electrode of a first electrode and a second electrode of the LED device is coupled to the metallic plates.

### TECHNICAL FIELD

The present invention relates to a light emitting diode (LED) lighting apparatus, and more particularly, to an LED lighting apparatus for illumination using LED device.

### BACKGROUND ART

Generally, a lighting apparatus is widely used as a lighting apparatus for illuminating the inside or the outside, or a notification means such as a traffic signal light and a warning light.

As the lighting apparatus, a filament which emits light by being heated to a high temperature when supplied with current is used. Recently, an LED lighting apparatus having low power consumption, high illuminance, and a long lifespan is being spotlighted.

However, the LED lighting apparatus cannot replace the conventional lighting apparatus using filament, since it has low diffusion characteristic of light due to high straight characteristic of light, and since side illuminance is weak.

FIGS. 1 and 2 illustrate the conventional lighting apparatus 1 having a light bulb 10 in a car. As shown, the conventional lighting apparatus 1 has a reflection member 20, such as a headlight or a fog lamp, a member optimized for implementation of functions.

As shown in FIG. 2, the reflection member 20 is designed in an optimum manner, in correspondence to a position of a filament (i.e., a light emitting part 11 of the light bulb 10 in a car), e.g., a distance (I) from a socket 12 coupled to the inside of the lighting apparatus 1.

In case of replacing the conventional lighting apparatus 1 by an LED lighting apparatus, the reflection member 20 cannot be reused from the conventional lighting apparatus 1, due to an optical characteristic of an LED which has a straight characteristic in one direction, differently from the conventional light bulb 10 which is irradiated to all directions. Accordingly, a reflection member which is designed additionally is required.

In case of replacing the conventional lighting apparatus 1 by an LED lighting apparatus, replacement costs are high since a reflection member should be re-designed, etc. This may cause limitation in utilizing the LED lighting apparatus and diffusing light.

### DISCLOSURE

### Technical Problem

Therefore, an object of the present invention is to provide an LED lighting apparatus capable of having similar illumination effect to the conventional one, without changing structure of the conventional illumination equipment.

Another object of the present invention is to provide an LED lighting apparatus capable of replacing a light bulb in the conventional illumination assembly such as a headlamp and a fog lamp of an automobile using a light bulb, without changing a structure.

Another object of the present invention is to provide an LED lighting apparatus capable of having similar illumination effect to a light bulb, without changing structure of the conventional illumination equipment where an optimized reflector is provided at a light bulb.

Still another object of the present invention is to provide an LED lighting apparatus capable of having similar illumination effect to a light bulb, without changing structure of the conventional illumination equipment where an optimized reflector is provided at a light bulb by two or more light sources especially, a car lighting apparatus, by positioning LED devices in correspondence to the light sources by the light bulb.

### Technical Solution

To achieve these and other advantages and in accordance with the purpose of the present invention, as embodied and broadly described herein, there is provided an LED lighting apparatus, including: one or more metallic plates; and one or more LED devices installed on a surface of the metallic plates, wherein only one electrode of a first electrode and a second electrode of the LED device is coupled to the metallic plates.

The LED device may be mounted to a printed circuit board coupled to the metallic plate, and one electrode of a first electrode and a second electrode of the printed circuit board may be coupled to the metallic plates.

A socket unit for coupling with a structure where the LED lighting apparatus is to be installed may be coupled to one end of the pair of metallic plates.

The metallic plate may include a plurality of metallic plates arranged such that their surfaces where the LED device has been installed are partially inclined from each other.

The metallic plate may include one or more bent metallic plates including an installation portion where the LED device is installed, and a bent portion extending from the installation portion.

The metallic plate may include a first metallic plate and a second metallic plate arranged in parallel to each other, and having one or more LED devices on opposite surfaces to facing surfaces.

The metallic plate may include one or more bent metallic plates including an installation portion where the LED device is installed, and a bent portion extending from the installation portion.

When a coupling direction of the socket unit is a lengthwise direction, the bent metallic plate may include one or more first bent metallic plates that a normal line of the installation portion is perpendicular to the lengthwise direction.

When a coupling direction of the socket unit is a lengthwise direction, the bent metallic plate may include one or more second bent metallic plates that a normal line of the installation portion is parallel to the lengthwise direction.

The metallic plate may be provided with a contact prevention means for preventing contact of non-contact electrode such that only one of the first electrode and the second electrode of the LED device is thermally-conducted, at a position corresponding to the non-contact electrode which is not thermally-conducted.

The contact prevention means may be a through hole formed at the metallic plate.

The non-contact electrode may be connected to a power connection line for connection with a terminal of another LED device or a power supply line, via the through hole.

The contact prevention means may be an insulating member formed at the metallic plate.

The LED device may be coupled to a printed circuit board coupled to the metallic plate, and a heat slug of the printed circuit board may be coupled to the metallic plates.

The socket unit may include a body detachably coupled to a structure and formed of non-conductive material; a terminal connection portion installed at the body, and configured to electrically connect the socket unit with a connection terminal installed at the structure; and a device power supply portion configured to electrically connect the LED device with the terminal connection portion.

The metallic plate may be fixedly-coupled to the socket unit.

The device power supply portion may include a plurality of terminal parts electrically connected to the terminal connection portion; a supporting substrate part coupled to the body, and configured to support the metallic plate; and one or more wires configured to connect the LED device with the terminal parts.

The LED lighting apparatus may be installed at one of a headlight, a fog lamp, a turn signal lamp, and a taillight of a car where a light bulb is installed, and the LED device may be coupled to the metallic plate so as to be located in correspondence to a light emitting part of the light bulb when the light bulb is installed at a car.

According to another aspect of the present invention, there is provided an LED lighting apparatus, including: a metallic plate; and one or more LED devices installed on a surface of the metallic plate, wherein only a heat slug of the LED device is coupled to the metallic plates.

According to another aspect of the present invention, there is provided an LED lighting apparatus, including: a socket unit 230 for coupling with a structure where the LED lighting apparatus is to be installed; a pair of first metallic plates 110-5 having one end coupled to the socket unit 230, and having first LED devices 120a on opposite surfaces to facing surfaces; a pair of second metallic plates 110-6 disposed between the pair of first metallic plates 110-5 in parallel to the pair of first metallic plates 110-5, having one end coupled to the socket unit 230, and having second LED devices 120b on opposite surfaces to facing surfaces; one or more third metallic plates 110-6 disposed between the pair of second metallic plates 110-6 in parallel to the pair of second metallic plates 110-6, having one end coupled to the socket unit 230, having a bent portion 113 bent so as to be perpendicular to the second metallic plates 110-6, and having a third LED device 120c on the bent portion 113; and an interval maintenance member 280 coupled to another end of the first to the third metallic plates, and configured to maintain intervals among the first to the third metallic plates.

The first to the third LED devices 120a, 120b, 120c may be coupled to the first to the third metallic plates, respectively, for thermal conduction, and only one electrode of the first and the second electrodes of each LED device may be coupled to each metallic plate.

The first metallic plates 110-5 may be provided with a cut-out portion 310 through which the second LED device 120b installed at the second metallic plates 110-6 disposed at an inner side is exposed to the outside.

The first LED device and the second LED device may be installed to have different distances from the socket unit 280.

The LED lighting apparatus may be installed at a headlight of a car, instead of a light bulb having two filaments, such that a high beam and a low beam are implemented by a single light bulb, and one of the first LED device 120a and the second LED device 120b may be disposed at a filament corresponding to the high beam, and another thereof may be disposed at a filament corresponding to the low beam.

The socket unit 230 may include a first terminal 237 and a second terminal 238 configured to connect one of the first LED device 120a and the second LED device 120b with the third LED device 120c, in series or in parallel; and a third terminal 239 installed at the socket unit 230, and configured to connect the second terminal 238 with another of the first LED device 120a and the second LED device 120b in series, which with such a configuration, power may be connected to at least one of the first terminal 237 and the third terminal 239, and the second terminal 238 may be shared.

Each of the first to the third metallic plates may be provided with a contact prevention means for preventing contact of non-contact electrode such that only one electrode of a first electrode and a second electrode of the first, second and third LED devices 120a, 120b, 120c is thermally conduced, at a position corresponding to the non-contact electrode which is not thermally-conducted.

The contact prevention means may be a through hole or a cut-out portion formed at each of the first to the third metallic plates.

The non-contact electrode may be connected to a power connection line for connection with a terminal of another LED device or a power supply line, via the through hole or the cut-output portion.

The contact prevention means may be an insulating member formed at each of the first to the third metallic plates.

The socket unit may include a body detachably coupled to a structure and formed of a non-conductive material; a terminal connection portion installed at the body, and configured to electrically connect the socket unit with a connection terminal installed at the structure; and a device power supply portion configured to electrically connect the LED device with the terminal connection portion.

The device power supply portion may include a plurality of terminal parts electrically connected to the terminal connection portion; a supporting substrate part coupled to the body and configured to support the metallic plate; and one or more wires configured to connect the LED device with the terminal parts.

### Advantageous Effects

The LED lighting apparatus of the present invention may have the advantage in that since an LED device is installed on one or more metallic plates, heat generated from the LED device is transmitted to the metallic plate to thus be radiated. Such a radiation structure is simple and efficient.

In addition, the LED lighting apparatus of the present invention may have the advantage in that since the LED lighting apparatus of the present invention has a similar light irradiation effect to a light bulb, as it is implemented as a pair of metallic plates to which LED devices are coupled to surfaces opposite to facing surfaces, the LED lighting apparatus of the present invention can maximize its utilization degree by replacing the light bulb used in the conventional lighting apparatus.

In particular, the conventional illumination equipment using a light bulb is provided with a reflector, and the reflector is optimized in correspondence to a light emitting part of a light bulb. In the LED lighting apparatus of the present invention, an LED device is installed on one or more metallic plates, in this case, the LED device is positioned in correspondence to a light emitting part of the conventional light bulb, thereby having a similar light irradiation effect to the light bulb. As the LED lighting apparatus of the present invention replaces the light bulb used in the conventional lighting apparatus, a utilization degree of the LED lighting apparatus can be maximized.

When the LED lighting apparatus of the present invention is applied to a headlight, a fog lamp, a turn signal lamp, etc. for automobile, there are the following advantages.

Firstly, when the LED lighting apparatus of the present invention is applied to a headlight, a fog lamp, a turn signal lamp, etc. for automobile which requires a special illumination effect, the conventional lighting apparatus having a light bulb should change a design of a reflector, since the LED lighting apparatus of the present invention has a different illumination characteristic from the light bulb.

The LED lighting apparatus of the present invention is positioned in correspondence to a light emitting part of the conventional light bulb, thereby having a similar light irradiation effect to the light bulb. As the LED lighting apparatus of the present invention replaces the light bulb used in the conventional lighting apparatus, a utilization degree of the LED lighting apparatus can be maximized.

Further, in the LED lighting apparatus of the present invention, an LED device is positioned in correspondence to each optical source of the conventional lighting apparatus where a high beam and a low beam are implemented by a single light bulb, by providing two filaments having different positions of optical sources. As the LED lighting apparatus of the present invention replaces the light bulb of the conventional lighting apparatus, its utilization degree can be maximized.

### DESCRIPTION OF DRAWINGS

FIG. 1 is a conceptual view illustrating a lighting apparatus having a light bulb in accordance with the conventional art, which illustrates a headlight for automobile.

FIG. 2 is a side sectional view illustrating an example of a light bulb used in the headlamp for automobile shown in FIG. 1.

FIG. 3A is a perspective view illustrating an LED lighting apparatus according to the first embodiment of the present invention.

FIG. 3B is a disassembled perspective view illustrating part of the LED lighting apparatus of FIG. 1.

FIG. 4A is a side sectional view of the LED lighting apparatus of FIG. 3A.

FIG. 4B is a planar view of the LED lighting apparatus of FIG. 3A.

FIG. 5 is a sectional view taken along line V-V in FIG. 3A.

FIG. 6 is a sectional view taken along line V-V in FIG. 3A, which shows a modification example of FIG. 5.

FIG. 7 is a side sectional view of an LED lighting apparatus according to a second embodiment of the present invention.

FIG. 8 is a planar view of the LED lighting apparatus of FIG. 7.

FIG. 9 is a side sectional view of an LED lighting apparatus according to a third embodiment of the present invention.

FIG. 10 is a planar view of the LED lighting apparatus of FIG. 9.

FIG. 11 is a side sectional view of an LED lighting apparatus according to a fourth embodiment of the present invention.

FIG. 12 is a disassembled perspective view of the LED lighting apparatus of FIG. 11.

FIG. 13A is a planar view of the LED lighting apparatus shown in FIG. 11, and FIG. 13B is a side sectional view of the LED lighting apparatus shown in FIG. 11.

FIG. 14 is a conceptual view illustrating an example of an equivalent circuit diagram of the LED lighting apparatus shown in FIG. 11.

FIG. 15 is a conceptual view illustrating an example where the LED lighting apparatus of FIG. 11 is installed at the conventional lighting apparatus having a light bulb.

FIG. 16 is a side sectional view of an LED lighting apparatus according to the fifth embodiment of the present invention, which is a perspective view illustrating an example where a light shielding unit is added to a configuration of a fourth embodiment.

FIG. 17A is a planar view of the LED lighting apparatus shown in FIG. 16, and FIG. 17B is a side sectional view of the LED lighting apparatus shown in FIG. 16.

FIG. 18 is a side sectional view of an LED lighting apparatus according to the sixth embodiment of the present invention.

FIG. 19 is a planar view of the LED lighting apparatus shown in FIG. 18.

FIG. 20 is a disassembled perspective view of the LED lighting apparatus shown in FIG. 18.

FIG. 21A is a planar view illustrating a first metallic plate and a covering metallic plate of the LED lighting apparatus shown in FIG. 18.

FIG. 21B is a planar view illustrating a second metallic plate and a covering metallic plate of the LED lighting apparatus shown in FIG. 18.

FIG. 21C is a planar view illustrating an intermediate metallic plate of the LED lighting apparatus shown in FIG. 18.

FIGS. 22A to 22D are planar views illustrating a method for manufacturing an LED lighting apparatus according to the present invention.

FIG. 23 is a sectional view of an LED lighting apparatus according to a seventh embodiment of the present invention.

FIG. 24 is a perspective view illustrating a configuration of a metallic member of the LED lighting apparatus shown in FIG. 23.

FIG. 25 is a planar view illustrating a metallic plate for manufacturing the metallic member of FIG. 24.

FIG. 26 is a sectional view taken along line A-A in FIG. 24.

FIG. 27 is a perspective view of an LED lighting apparatus according to an eighth embodiment of the present invention.

FIG. 28 is a planar view illustrating a metallic plate for manufacturing a metallic member of FIG. 27.

FIG. 29 is a perspective view of an LED lighting apparatus according to a ninth embodiment of the present invention.

FIG. 30 is a sectional view taken along line B-B in FIG. 29.

FIG. 31 is a bottom view of an LED lighting apparatus according to a tenth embodiment of the present invention, and

FIG. 32 is a sectional view taken along line C-C in FIG. 30.

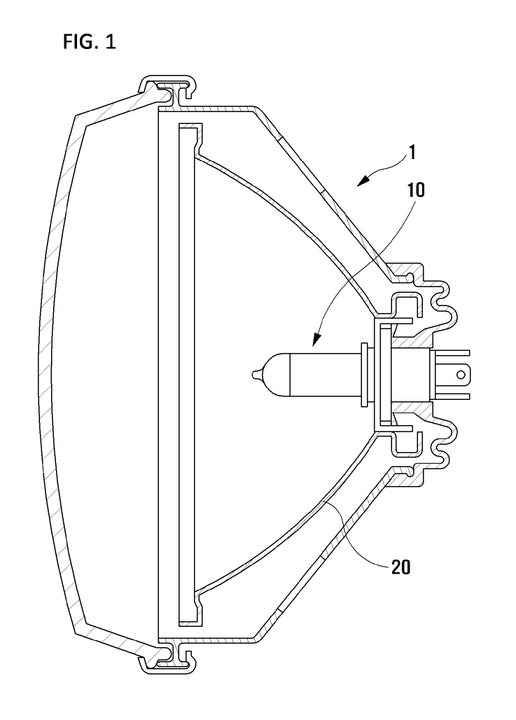

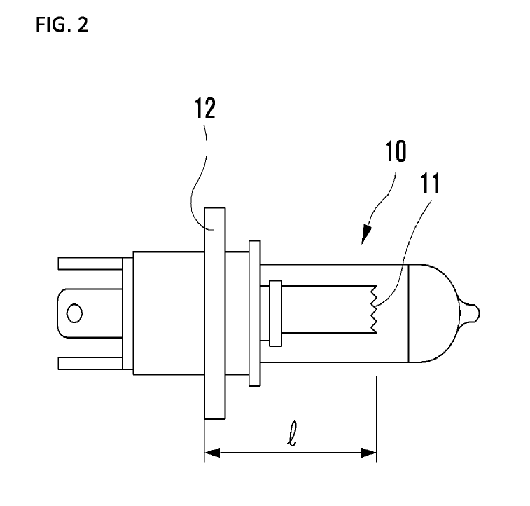

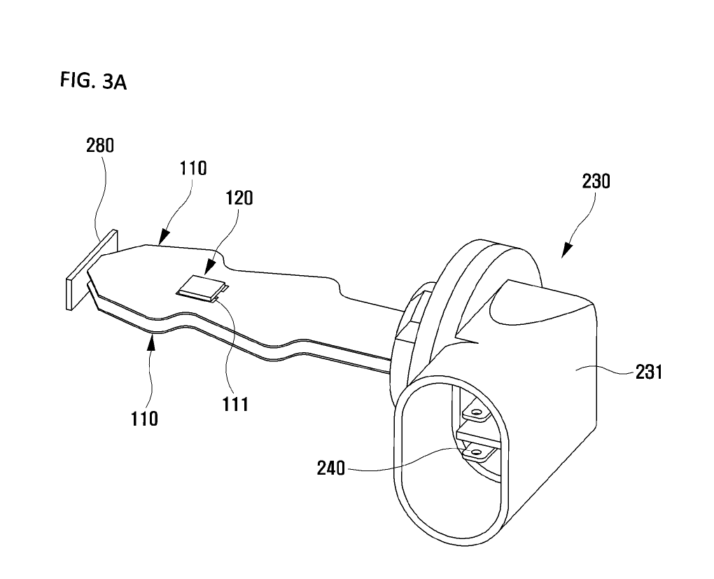

### MODE FOR INVENTION

Description will now be given in detail of an LED lighting apparatus according to an embodiment, with reference to the accompanying drawings.

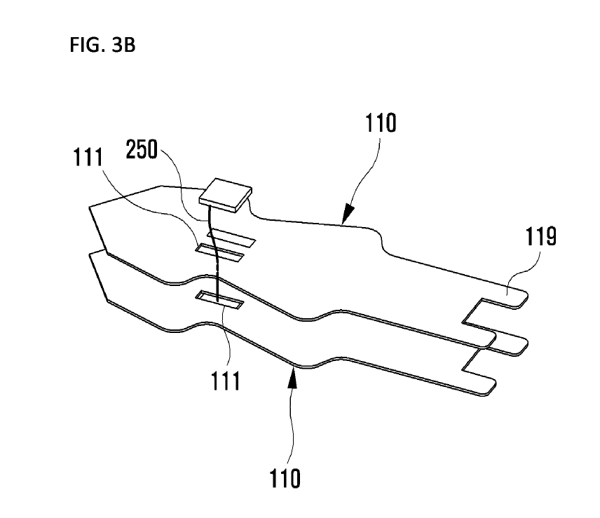

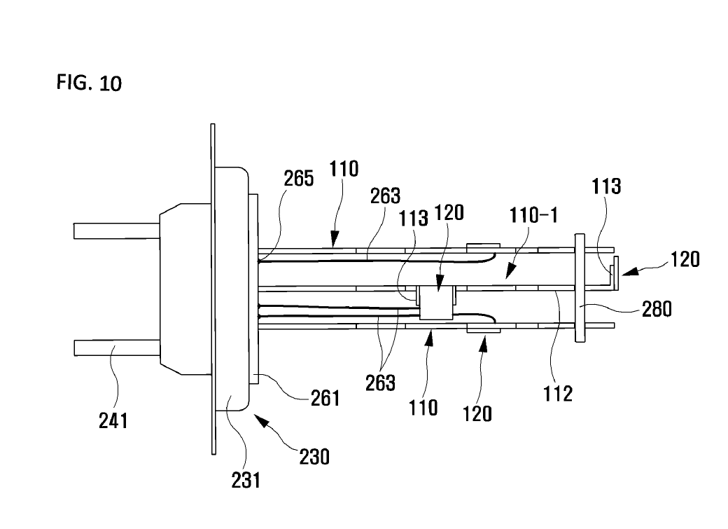

As shown in FIGS. 3A to 10, the LED lighting apparatus according to the present invention includes one or more metallic plates 110, and one or more LED devices 120 installed on the surface of the metallic plate 110.

The metallic plate 110 has a plate shape such that the LED device 120 is installed and supported thereon. And the metallic plate 110 may be formed of any material having high thermal conductivity, such as aluminum, aluminum alloy, copper, copper alloy, and SUS, for facilitation of heat radiation.

Preferably, the metallic plate 110 may be formed of copper or copper alloy with consideration of processability, thermal conductivity and electric conductivity.

Preferably, a thickness of the metallic plate 110 is minimized if there is no limitation in structural intensity and manufacturing.

The thickness of the metallic plate 110 is preferably within the range of 0.01 mm˜0.5 mm, and is more preferably within the range of 0.1 mm˜0.4 mm.

The surface of the metallic plate 110 may be coated with a material having high reflectivity such as silver, for an enhanced reflection effect of light irradiated from the LED device 120, etc.

At least part of the surface of the metallic plate 110 may be coated with an insulating material for providing an insulation property.

The surface of the metallic plate 110 may be plated with nickel.

A wire for power connection to the LED device 120 may be attached to the metallic plate 110, or the metallic plate 110 may be printed.

Circuitry of the metallic plate 110 may be formed to have a circuitry pattern.

A board such as an FPCB, where the LED device 120 is installed, may be coupled to the metallic plate 110.

A synthetic resin material for preventing solder from being out of soldering region may be printed on the metallic plate 110 during a manufacturing process, for coupling with the LED device 120.

The metallic plate 110 may have various shapes with consideration of a heat radiation effect of the LED device 120, a light irradiation effect of the LED device 120 when the LED device 120 is formed in plurality, etc.

More specifically, as shown in FIGS. 3A and 3B, the metallic plate 110 may have a plate shape. For instance, the metallic plate 110 may have a planar shape similar to a bulb.

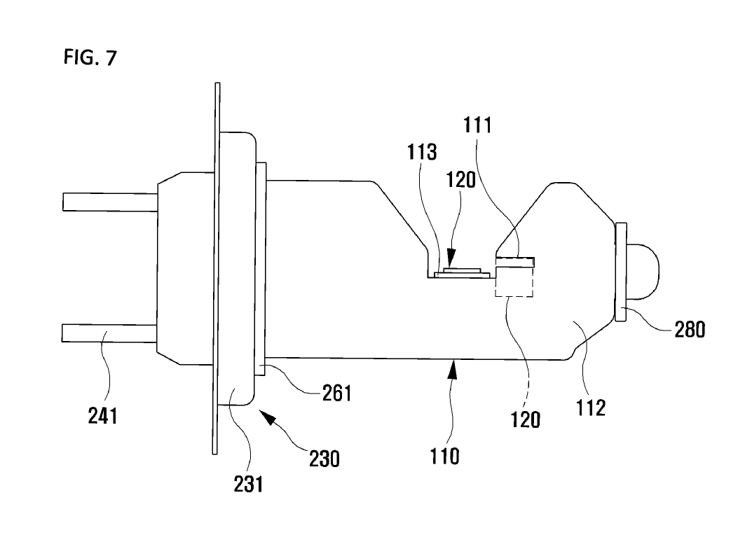

As shown in FIGS. 7 to 10, the metallic plate 110 may be implemented as a bent metallic plate 110-1 including an installation portion 112 where the LED device 120 is installed, and a bent portion 113 extending from the installation portion 112.

The bent metallic plate 110-1 includes the installation portion 112 integrally formed with the bent portion 113 coupled to a supporting structure such as a socket unit 230 such that the metallic plate 110 is formed in plurality and a light irradiation effect of the LED device 120 is maximized.

The installation portion 112, part to determine a light irradiation direction of the LED device 120, is formed such that a normal line of an installation surface of the LED device 120 is parallel to a light irradiation direction of the LED device 120.

The bent portion 113, part to support the LED device 120 by being integrally formed with the installation portion 112, is preferably formed in parallel to the adjacent metallic plate 110. Alternatively, the bent portion 113 may be formed to be perpendicular to, or inclined from the adjacent metallic plate 120, thereby being coupled to a supporting structure such as the socket unit 230.

Preferably, the metallic plate 110 is formed in plurality. When the metallic plate 110 is formed in plurality, the metallic plates 110 may be disposed such that their surfaces where the LED devices 120 are installed are parallel to each other, perpendicular to each other, or inclined from each other.

The metallic plate 110 may has the following advantages. 1) the metallic plate 110 may directly and stably support the LED device 120. For reference, an FPCB cannot support the LED device 120 by itself, and has a very low heat radiation effect since it is formed of a synthetic resin material having a low thermal conductivity. In case of a metallic PCB, there is an insulation layer for insulation between a printed circuit board and a metallic layer (aluminum). More specifically, heat is transferred in order of the LED device 120, solder, a copper wire, an adhesion layer, an insulation layer, an adhesion layer, and an aluminum metallic layer. In this case, a heat radiation effect is low due to a bottleneck phenomenon occurring during heat radiation, and the metallic PCB has a great thickness. 2) The metallic plate 110 may serve as an electric conductor for power supply to the LED device 120, by being directly connected to one of a first terminal 121 and a second terminal 122 of the LED device 120. 3) The metallic plate 110 may serve as a heat radiation member for receiving heat from the LED device 120 and radiating the heat. Especially, the metallic plate 110 may effectively radiate heat by being connected to at least one of the first terminal 121, the second terminal 122 and a heat slug 124 of the LED device 120, by soldering, etc. 4) The metallic plate 110 may enhance the conventional effect to utilize a reflector by being positioned on an optimum position of a light emitting part (filament) of a light bulb, under a simple structure.

The LED device 120, which emits light by power supply from a DC power source, may be implemented in various manners. For instance, the LED device 120 may be implemented as a white LED device for emitting white light, a yellow LED device for emitting yellow light, a blue LED device, a red LED device, a green LED device, a three-color LED chip where a blue LED device, a red LED device and a green LED device are formed as a single chip, etc.

The LED device 120 is preferably implemented as a chip including a single LED semiconductor device.

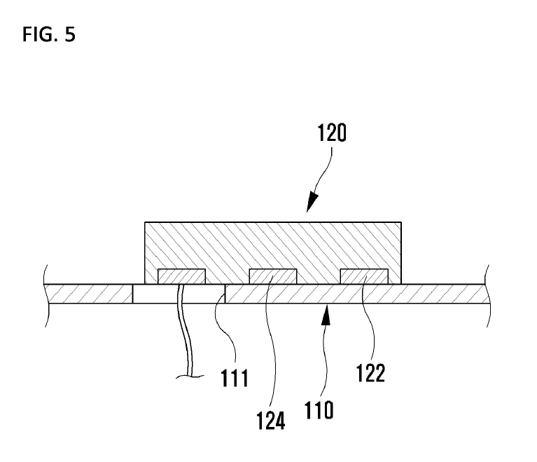

For instance, as shown in FIG. 5, the LED device 120 may include a first electrode 121, a positive terminal (+), and a second electrode 122, a negative terminal (−).

As shown in FIG. 5, the LED device 120 may include a first electrode 121, a positive terminal (+), a second electrode 122, a negative terminal (−), and a heat slug 124 for heat radiation.

The heat slug 124 for radiation of heat generated from the LED device 120 may be integrally formed with the first electrode 121 and the second electrode 122.

FIG. 5 is a view illustrating the first electrode 121, the second electrode 122 and the heat slug 124 of the LED device 120. The structure of the LED device 120 shown in FIG. 5 may be different from a substantial structure of the LED device 120.

The LED device 120 may be coupled to the metallic plate 110 such that only one of the first electrode 121 and the second electrode 122 is thermally-conducted with the metallic plate 110.

If the LED device 120 additionally includes the heat slug 124, the LED device 120 may be coupled to the metallic plate 110 such that only the heat slug 124 is thermally-conducted with the metallic plate 110.

As shown in FIGS. 3A to 5, the LED device 120 may be directly coupled to the metallic plate 110.

In this case, since only one electrode of the first electrode 121 and the second electrode 122 is conducted with the metallic plate 110, the other electrode of the first electrode 121 and the second electrode 122 is electrically insulated from the metallic plate 110.

More specifically, the metallic plate 110 may be provided with a contact prevention means 111 for preventing contact of the non-contact electrode such that only one electrode of the first electrode 121 and the second electrode 122 of the LED device 120 is thermally-conducted, at a position corresponding to the non-contact electrode which is not thermally-conducted.

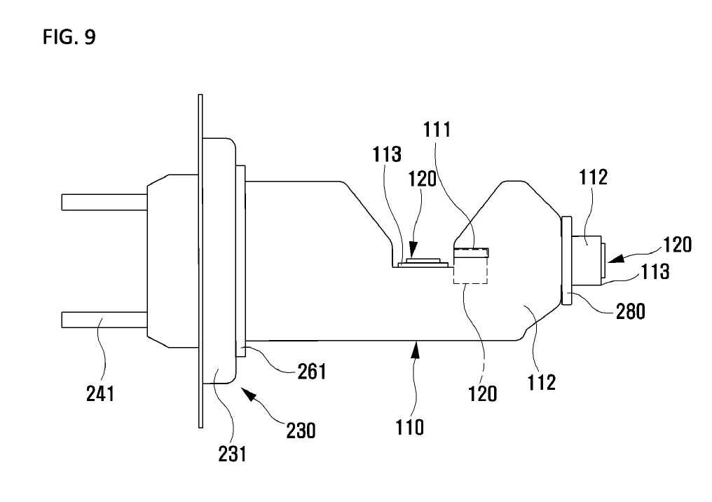

As shown in FIG. 5, the contact prevention means 111, may be implemented as a through hole formed at the metallic plate 110, or a cut-out portion as shown in FIGS. 7 and 9.

In this case, as shown in FIG. 5, the non-contact electrode may be connected to a power connection line 250 for connection with a terminal of the other LED device or a power supply line, via the through hole or a cut-out portion (the cut-out portion shown in FIGS. 7 and 9).

The power connection line 250 may be connected to each LED device 110 according to the first embodiment to be explained later, thereby being used to maintain an interval between the metallic plates 110 arranged in parallel to each other. The interval between the metallic plates 110 arranged in parallel to each other may be maintained by an interval maintenance member 280 to be explained later.

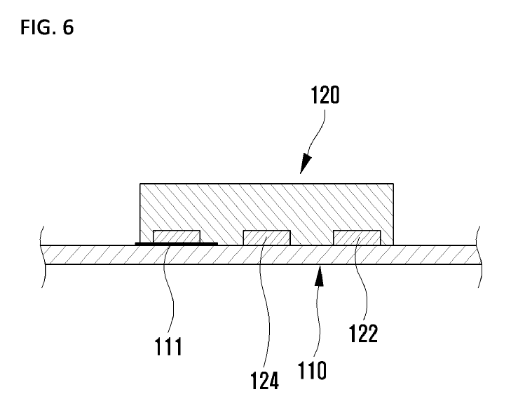

As another example, as shown in FIG. 6, the contact prevention means 111 may be implemented as an insulation member 111 of the metallic plate 110.

The insulation member 111, configured to electrically insulate the LED device 120 and the metallic plate 110 from each other, may be implemented as an insulating material coated on the surface of the metallic plate 110, an insulation tape attached onto the metallic plate 110, etc.

Unlike in FIG. 5, if only the heat slug 124 electrically insulated from the first electrode 121 and the second electrode 122 is coupled to the metallic plate 110 so as to be thermally-conducted with the metallic plate 110, the LED device 120 is installed such that the first electrode 121 and the second electrode 122 are electrically insulated from the metallic plate 110.

Unlike in FIG. 5, the LED device 120 may be mounted to a printed circuit board (not shown) coupled to the metallic plate 110, without being directly coupled to the metallic plate 110. In this case, like in the case where the LED device 120 is directly coupled to the metallic plate 110, the printed circuit board may be coupled to the metallic plate 110 such that one of the first electrode 121 and the second electrode 122 is thermally-conducted with the metallic plate 110.

The LED device according to the present invention has a basic structure of the LED device 120 and the metallic plate 110 to which the LED device 120 is coupled. The LED devices 120 and the metallic plates 110 may be formed in plurality. In this case, the metallic plates 110 may be arranged in parallel to each other, or may be partially inclined from each other. With such various arrangements, a lighting apparatus having various illumination effects may be implemented.

As a basic structure of the LED device 120 and the metallic plate 110 to which the LED device 120 is coupled is implemented in plurality, an illumination effect such as a light bulb may be obtained. Especially, since a lighting apparatus using a light bulb, such as a headlamp, a fog lamp and a turn signal lamp for automobile, has the light bulb replaced, a utilization effect of the LED lighting apparatus may be maximized.

Hereinafter, it will be explained that the LED lighting apparatus of the present invention is applied to a headlamp, a fog lamp and a turn signal lamp for automobile.

As shown in FIGS. 3A to 5, the LED lighting apparatus according to the first embodiment of the present invention has a basic structure of the LED device 120 and the metallic plate 110 to which the LED device 120 is coupled. The metallic plate 110 may include a first metallic plate and a second metallic plate arranged in parallel to each other, and having one or more LED devices 120 on opposite surfaces to facing surfaces to each other.

The socket unit 230 for coupling with a lighting apparatus for automobile, i.e., a structure where the LED lighting apparatus is to be installed, may be coupled to one end of the pair of metallic plates 110.

The metallic plates 110 may be coupled to the socket unit 230 in various manners. For instance, the metallic plates 110 may be coupled to the socket unit 230 in a fixed manner or in a detachable manner.

The socket unit 230 for coupling with a lighting apparatus for automobile, i.e., a structure where the LED lighting apparatus is to be installed, may have various configurations according to a coupling method with the structure.

For instance, the socket unit 230 may include a body 231 detachably coupled to a structure, a terminal connection portion 240 installed at the body 231 and configured to electrically connect the socket unit 230 with a connection terminal (not shown) installed at the structure, and a device power supply portion 260 configured to electrically connect the LED device 120 with the terminal connection portion 240.

The body 231, configured to stably couple the LED lighting apparatus to a structure, may be implemented as one or more members. And the body 231 may be formed of an insulating material, a metallic material, or a combination thereof.

The terminal connection portion 240, installed at the body 231 and configured to electrically connect the socket unit 230 with a connection terminal installed at the structure, may have various configurations according to a terminal connection method. In some cases, the terminal connection portion 240 may be integrally formed with the body 231.

The device power supply portion 260, configured to electrically connect the LED device 120 with the terminal connection portion 240, may be implemented as a substrate, a wire, a conductive member, etc. according to a connection structure between the terminal connection portion 240 and the LED device 120.

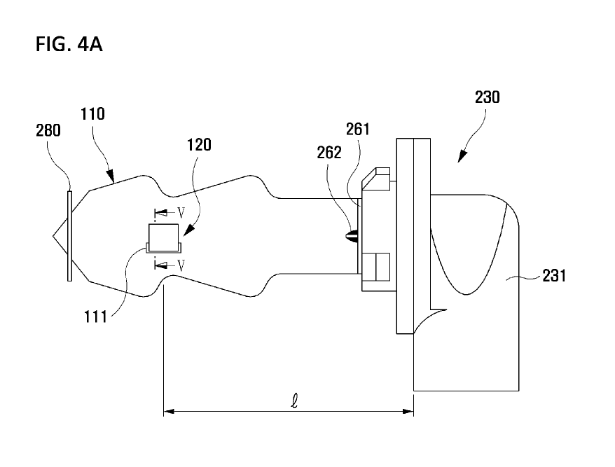

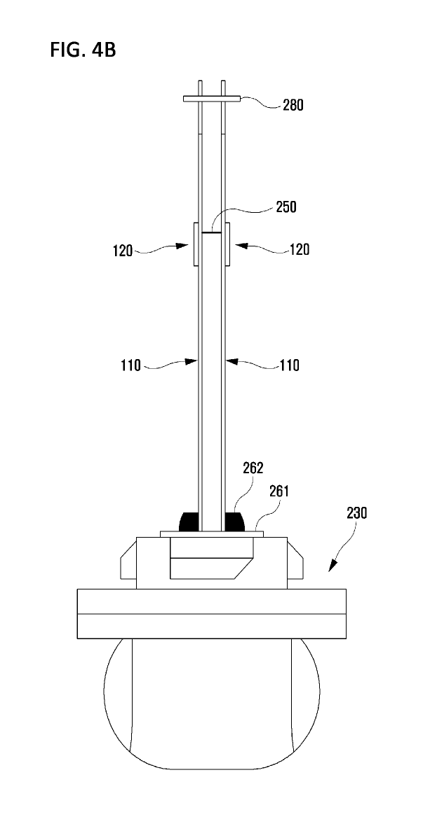

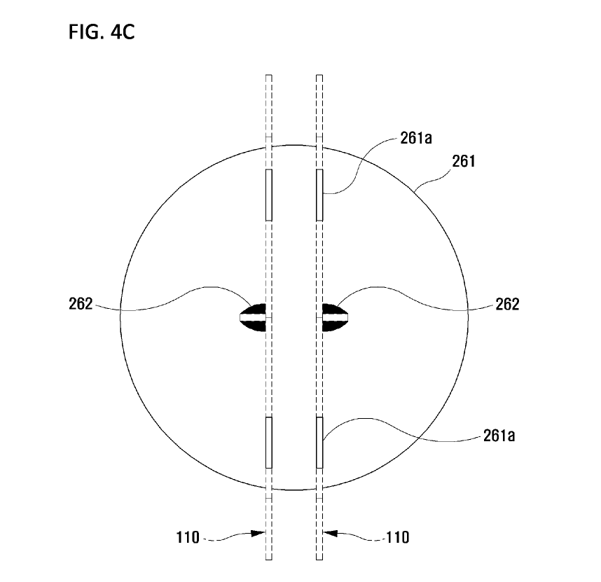

For instance, as shown in FIGS. 4A and 4B, the device power supply portion 260 may include a substrate 261 coupled to the metallic plate 110 so as to support the metallic plate 110, and coupled to the terminal connection portion 240; and a connection part 262 configured to supply power to the LED device 120.

The metallic plate 110 may be electrically connected to one electrode of the first electrode and the second electrode of the LED device 120.

The substrate 261 is configured to support the metallic plate 110, and is coupled to the terminal connection portion 240. The substrate 261 may have various configurations. For example, the substrate 261 may be provided with a through hole 261a for inserting a protrusion 119 of at least one of the metallic plates 110, and may have a circuitry pattern for conduction of the terminal connection portion 240 and the LED device 120.

The substrate 261 may constitute part or the entirety of the body 231 of the socket unit 230.

The connection part 262, configured to supply power to the LED device 120, may be implemented in various manners. For instance, the connection part 262 may be implemented as solder as shown in FIGS. 4A and 4B, or may be implemented as a wire as shown in FIGS. 7 to 10.

As shown in FIGS. 7 to 10, the device power supply portion 260, as another structure, may include the substrate 261 coupled to the body 231 and configured to support the metallic plate 110, the substrate 261 being formed with a plurality of terminal parts 265 electrically connected to the terminal connection portion 240, and one or more wires 263 configured to connect the LED device 120 with the terminal parts 265.

The wire 263 may be implemented as any electric conductive member such as a copper wire and an iron wire (a steel wire), as well as a usage wire that copper wires are installed in synthetic resin.

The wire 263 is preferably formed of copper or a copper alloy for heat radiation therefrom. More preferably, the wire 263 is coated with no insulating material on an outer surface thereof.

When the socket unit 230 for coupling with a structure where the LED lighting apparatus is to be installed, i.e., a lighting apparatus for automobile is coupled to one end of the pair of metallic plates 110, the interval maintenance member 280 configured to maintain an interval between the pair of metallic plates 110 may be additionally installed at the other end of the pair of metallic plates 110.

The interval maintenance member 280, configured to maintain an interval between the pair of metallic plates 110, is an insulating member formed of synthetic resin such as a printed circuit board (PCB). The interval maintenance member 280 is provided with through holes 281 for inserting the metallic plates 110. As the pair of metallic plates 110 are inserted into the through holes 281, the metallic plates 110 may be fixedly-coupled to the interval maintenance member 280.

In the LED lighting apparatus according to the first embodiment of the present invention, an arrangement and a position of the LED device 120 may be changed according to a characteristic of a light bulb of a lighting apparatus, the light bulb to be replaced.

More specifically, the LED lighting apparatus according to the first embodiment of the present invention is installed at one of a headlight, a fog lamp, a turn signal lamp and a taillight of a car where a light bulb is installed. As shown in FIG. 4A, the LED device 120 may be coupled to the metallic plate 110 so as to be disposed at a position corresponding to a position of a filament (i.e., a light emitting part of a light bulb) when the light bulb is installed in a car.

More specifically, the LED device 120 may be installed to have a distance (I) from the metallic plate 110 to the socket unit 230, in correspondence to the distance (I) from the socket unit 12 to the light emitting part 11 of the light bulb 10.

In the LED lighting apparatus according to the present invention, when a light bulb is installed at one of a headlight, a fog lamp, a turn signal lamp, and a taillight of a car, a light emitting characteristic in a side direction or a light emitting characteristic in a front direction should be enhanced according to a light emitting structure, a light emitting characteristic, etc. of a lighting apparatus to be installed.

As shown in FIGS. 7 to 10, in addition to the configuration according to the first embodiment, an LED lighting apparatus according to second and third embodiments of the present invention may include one or more bent metallic plates 110-1 including an installation portion 112 where the LED device 120 is installed, and a bent portion 113 extending from the installation portion 112.

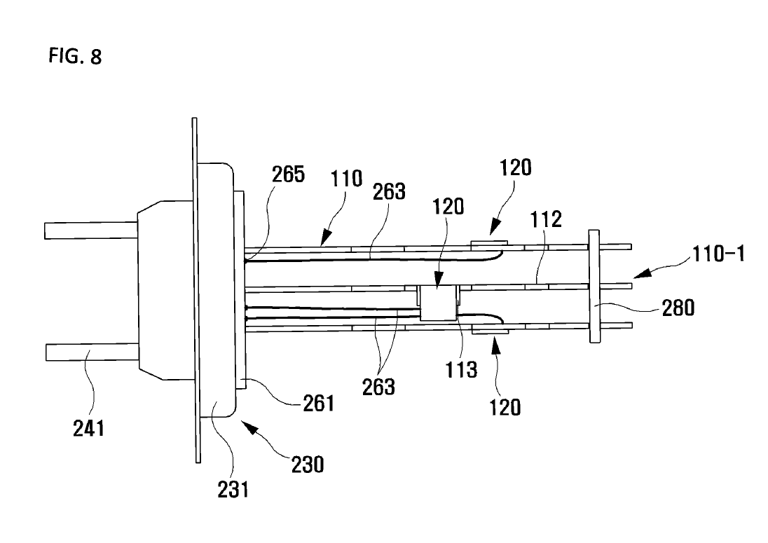

In the second embodiment of the present invention, when a coupling direction of the socket unit 230 is a lengthwise direction, the bent metallic plate 110-1 may include one or more first bent metallic plates that a normal line of the installation portion 112 is perpendicular to the lengthwise direction, i.e., a light emitting surface of the LED device 120 is toward a lateral side, as shown in FIGS. 7 and 8.

In the third embodiment of the present invention, when a coupling direction of the socket unit 230 is a lengthwise direction, the bent metallic plate 110-1 may include one or more second bent metallic plates that a normal line of the installation portion 112 is parallel to the lengthwise direction, i.e., a light emitting surface of the LED device 120 is toward a front side.

In a case where each of the metallic plate 110 and the LED device 120 is formed in plurality, an equivalent circuit thereof may be formed in parallel, in series, in series-parallel, etc., based on each LED device 120.

The metallic plate 110 may be conducted with part of the equivalent circuit, i.e., one electrode of the first and the second electrodes of the LED device 120.

In the LED lighting apparatus according to the present invention, various illumination effects may be implemented as the metallic plate where the LED device is installed is formed in plurality, and as a relative position of the LED device with respect to the metallic plate is changed.

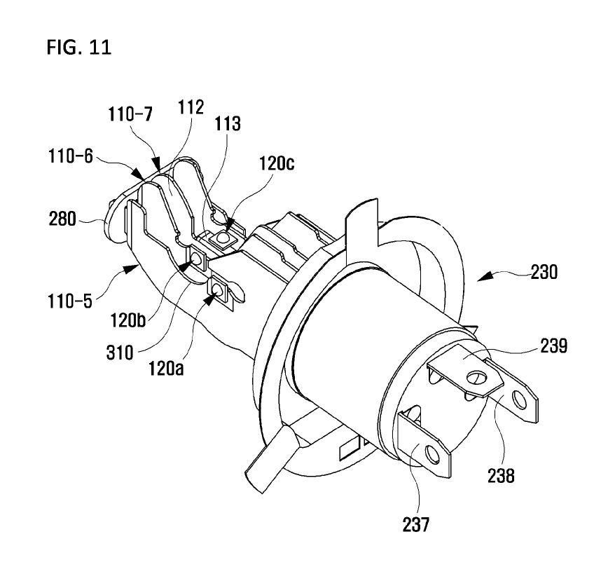

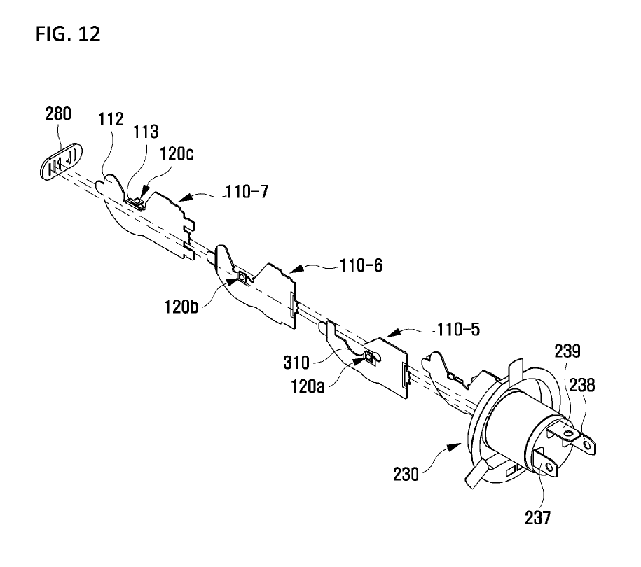

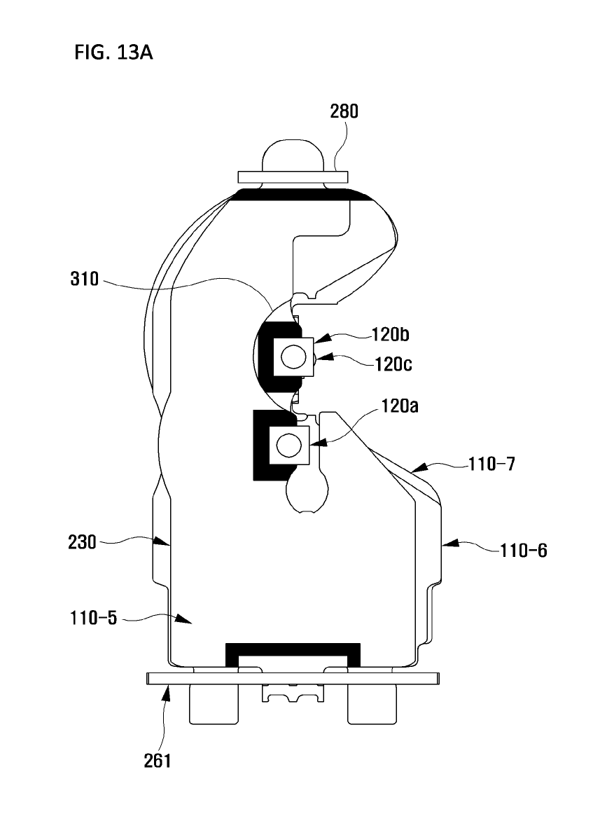

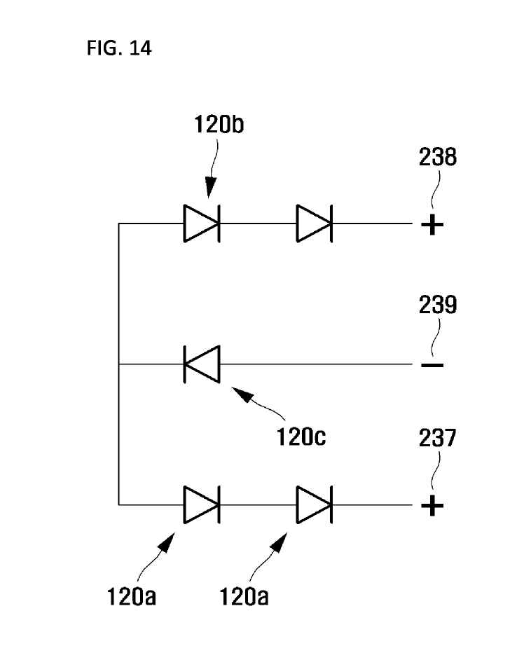

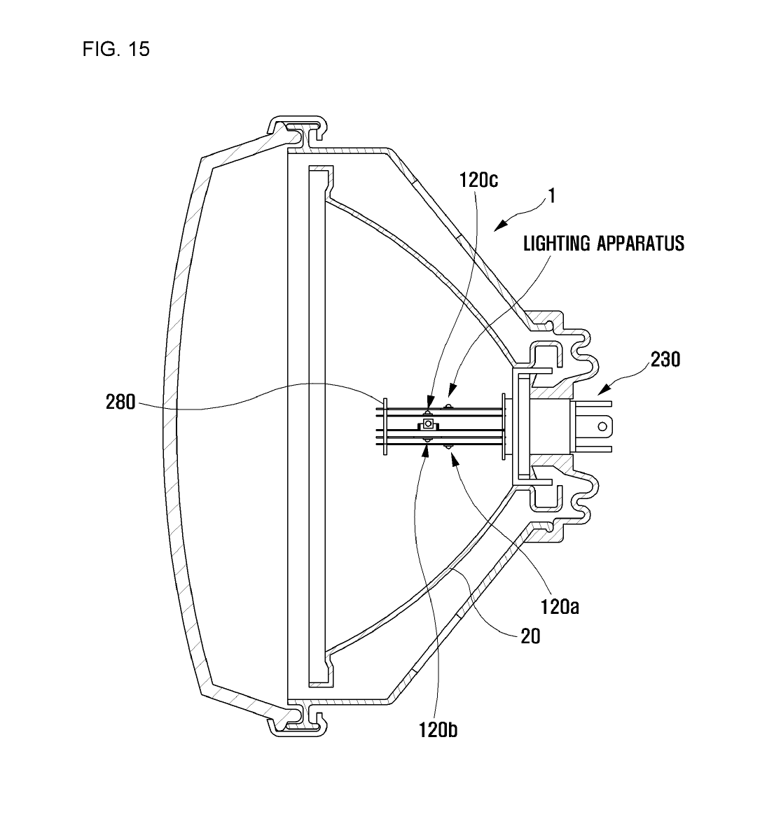

Hereinafter, an LED lighting apparatus according to a fourth embodiment of the present invention will be explained with reference to FIGS. 11 to 15. The LED lighting apparatus according to the fourth embodiment is different from the LED lighting apparatus according to the aforementioned embodiment in arrangement of the metallic plate, etc. The same or similar configuration as or to the configurations of the first to the third embodiments will not be explained.

As shown in FIGS. 11 to 15, the LED lighting apparatus according to the fourth embodiment includes a socket unit 230 for coupling with a structure where the LED lighting apparatus is to be installed; a pair of first metallic plates 110-5 having one end coupled to the socket unit 230, and having first LED devices 120a on opposite surfaces to facing surfaces; a pair of second metallic plates 110-6 disposed between the pair of first metallic plates 110-5 in parallel to the pair of first metallic plates 110-5, having one end coupled to the socket unit 230, and having second LED devices 120b on opposite surfaces to facing surfaces; one or more third metallic plates 110-6 disposed between the pair of second metallic plates 110-6 in parallel to the pair of second metallic plates 110-6, having one end coupled to the socket unit 230, having a bent portion 113 bent so as to be perpendicular to the second metallic plates 110-6, and having a third LED device 120c on the bent portion 113; and an interval maintenance member 280 coupled to another end of the first to the third metallic plates, and configured to maintain intervals among the first to the third metallic plates.

The first LED device 120a and the second LED device 120b are preferably installed to have different distances from the socket unit 230, in correspondence to two optical sources.

The first metallic plates 110-5 may be provided with cut-out portions 310 through which the second LED devices 120b installed at the second metallic plates 110-6 disposed at an inner side are exposed to the outside.

The LED lighting apparatus may be installed at a headlight of a car, instead of a light bulb having two filaments, such that a high beam and a low beam are implemented by a single light bulb.

One of the first LED device 120a and the second LED device 120b may be disposed at a filament corresponding to the high beam, and the other thereof may be disposed at a filament corresponding to the low beam.

A headlight of a car, which has a high beam and a low beam by a single LED lighting apparatus, includes a reflection member of a proper structure such that a low beam and a high beam are implemented by a single LED lighting apparatus.

The socket unit 230 may include a first terminal 237 and a second terminal 238 configured to connect one electrode of the first LED device 120a and the second LED device 120b with the third LED device 120c, in series or in parallel; and a third terminal 239 installed at the socket unit 230, and configured to connect the second terminal 238 with the other electrode of the first LED device 120a and the second LED device 120b in series.

With such a configuration, the first LED device 120a and the second LED device 120b are independently turned on/off, as power is connected to one of the first terminal 237 and the third terminal 239 in a state where the second terminal 238 is shared.

One of the first LED device 120a and the second LED device 120b (e.g., the second LED device 120b) and the third LED device 120c are disposed in correspondence to a low beam, and the other of the first LED device 120a and the second LED device 120b (e.g., the first LED device 120a) is disposed in correspondence to a high beam. Through the independent on/off of the first LED device 120a and the second LED device 120b, various illumination effects may be implemented, e.g., the high beam can be turned on/off.

In case of a car headlight which can serve as a high beam and a low beam by a single LED lighting apparatus, a reflection member is divided up and down. In this case, the upper reflection member serves as a low beam, and the lower reflection member serves as a high beam.

When one of the first LED device 120a and the second LED device 120b (e.g., the second LED device 120b) and the third LED device 120c are disposed in correspondence to a low beam, the third LED device 120c serves as a low beam since light generated from the third LED device 120c is toward the upper side. However, in this case, light generated from the second LED device 120b is toward a low beam region and a high beam region according to a radiation angle thereof. This may cause a problem that light is partially exposed to the high beam region.

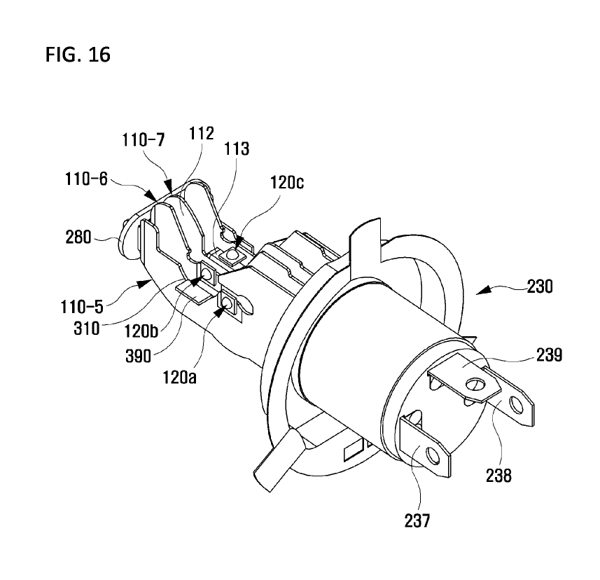

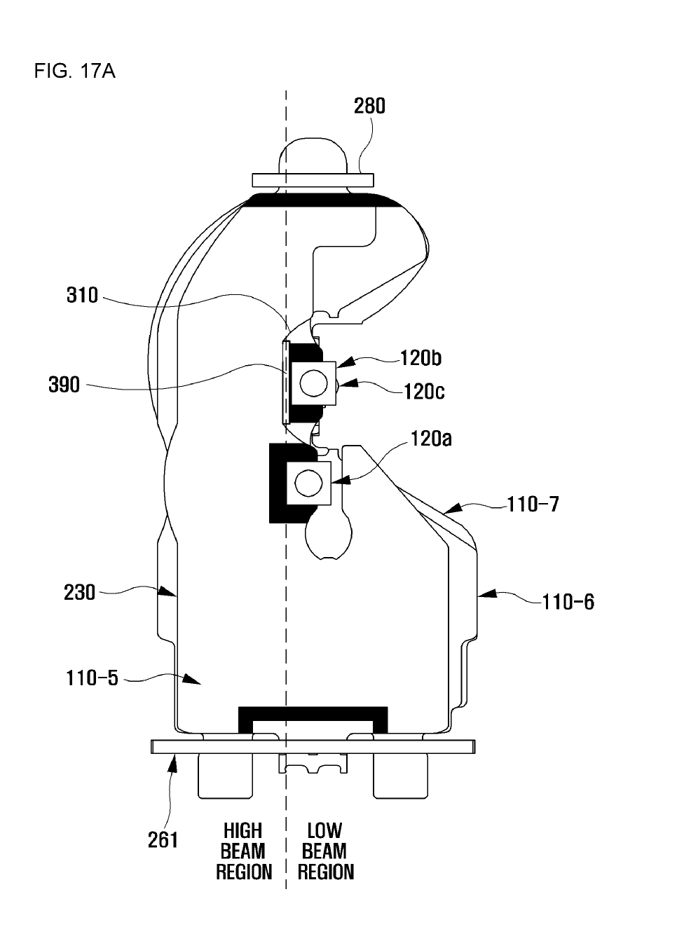

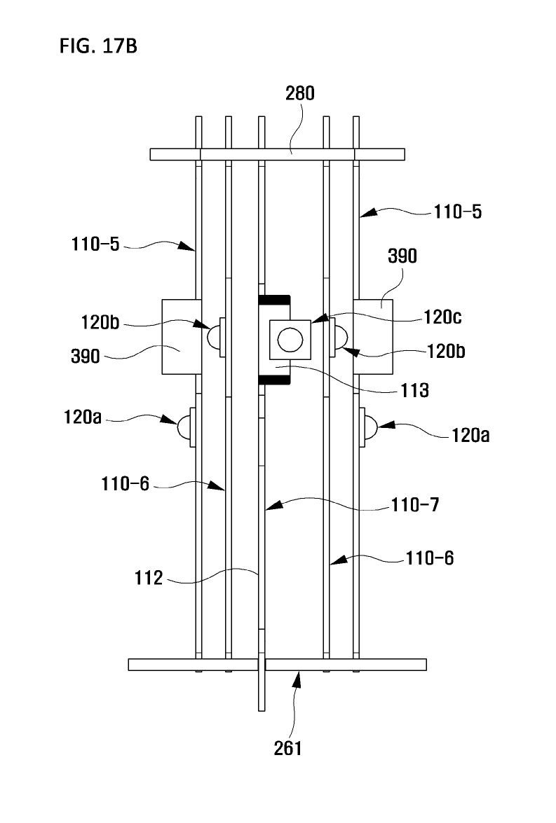

In order to solve such a problem, as shown in FIGS. 16 to 17A, the LED lighting apparatus according to the fifth embodiment of the present invention may further include a light shielding member 390 configured to prevent light generated from one of the first LED device 120a and the second LED device 120b which corresponds to a low beam (e.g., the second LED device 120b), from being irradiated onto a high beam region.

The light shielding member 390, configured to prevent light generated from one of the first LED device 120a and the second LED device 120b which corresponds to a low beam (e.g., the second LED device 120b), from being irradiated onto a high beam region, may have various configurations.

The light shielding member 390 is formed to have a size large enough to prevent light generated from one of the first LED device 120a and the second LED device 120b which corresponds to a low beam (e.g., the second LED device 120b), from being irradiated onto a high beam region.

As shown in FIGS. 16 to 17B, the light shielding member 390 is preferably installed at the metallic plate 110-5 which is disposed at the outermost side.

As shown in FIGS. 16 to 17B, when the light shielding member 390 is integrally formed with the metallic plate 110-5 which is disposed at the outermost side, in a partially bent manner by a predetermined angle (e.g., 90°).

For minimization of light reflection, a surface of the light shielding member 390, which faces the second LED device 120b, preferably undergoes a mat finishing, and is preferably painted in black color.

Like in the LED lighting apparatus according to the first to the third embodiments, in the LED lighting apparatus according to the fourth and fifth embodiments, the first to the third LED devices 120a, 120b, 120c may be coupled to the first to the third metallic plates, respectively, for thermal conduction. In this case, only one electrode of the first and the second electrodes of each LED device may be coupled to each metallic plate.

Like in the first to the third embodiments, each of the first to the third metallic plates may be provided with a contact prevention means for preventing contact of a non-contact electrode, at a position corresponding to the non-contact electrode which is not thermally-conducted. The contact prevention means is configured such that only one electrode of the first and the second electrodes of each of the first to the third LED devices 120a, 120b, 120c is thermally-conducted.

The contact prevention means may be a through hole or a cut-out portion formed at each of the first to the third metallic plates.

The non-contact electrode may be connected to a power connection line for connection with a terminal of another LED device or a power supply line, via the through hole or the cut-output portion.

The contact prevention means may be an insulating member formed at each of the first to the third metallic plates.

In the LED lighting apparatus according to the first to the fifth embodiments, each LED device may not be disposed at a predesigned optimum position of a reflector, since an interval between metallic plates where LED devices have been installed is increased.

Especially, in case of the second to fifth embodiments, the LED device positioned at the outermost side based on the metallic plate positioned at the center, is not disposed at a predesigned optimum position of a reflector.

Hereinafter, the LED lighting apparatus according to the sixth embodiment of the present invention will be explained. The same or similar configuration as or to the configurations according to the first to the fifth embodiments will not be explained, for convenience.

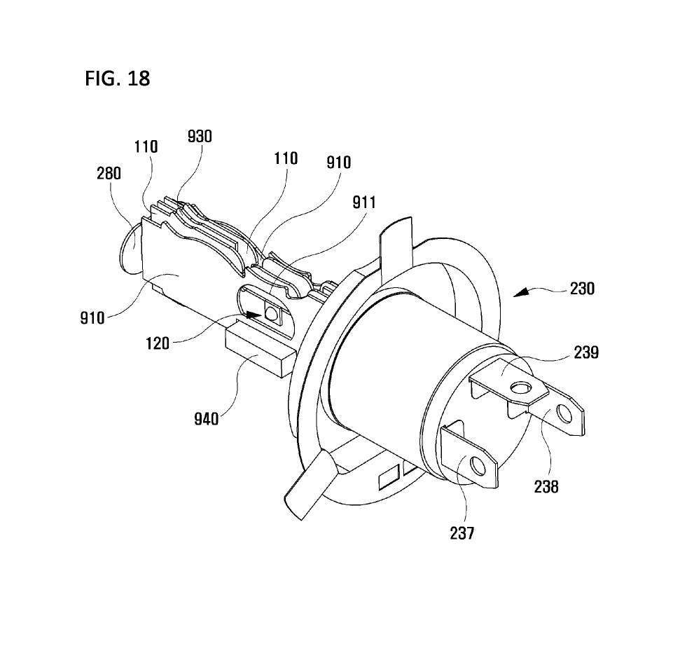

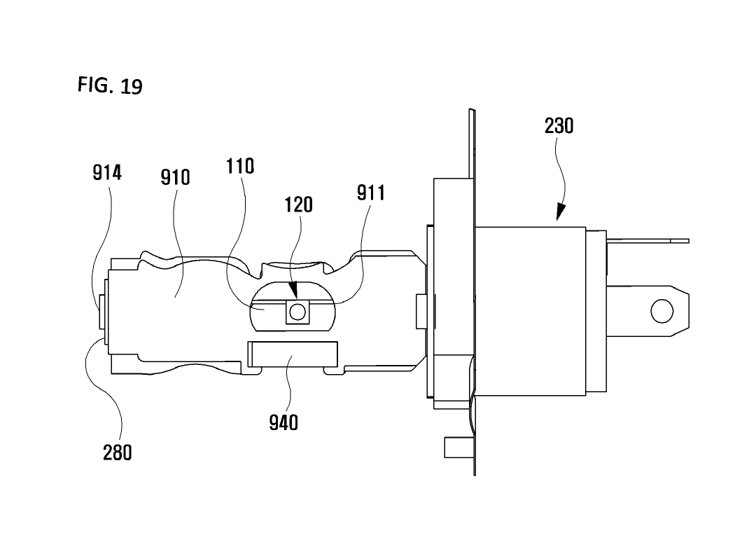

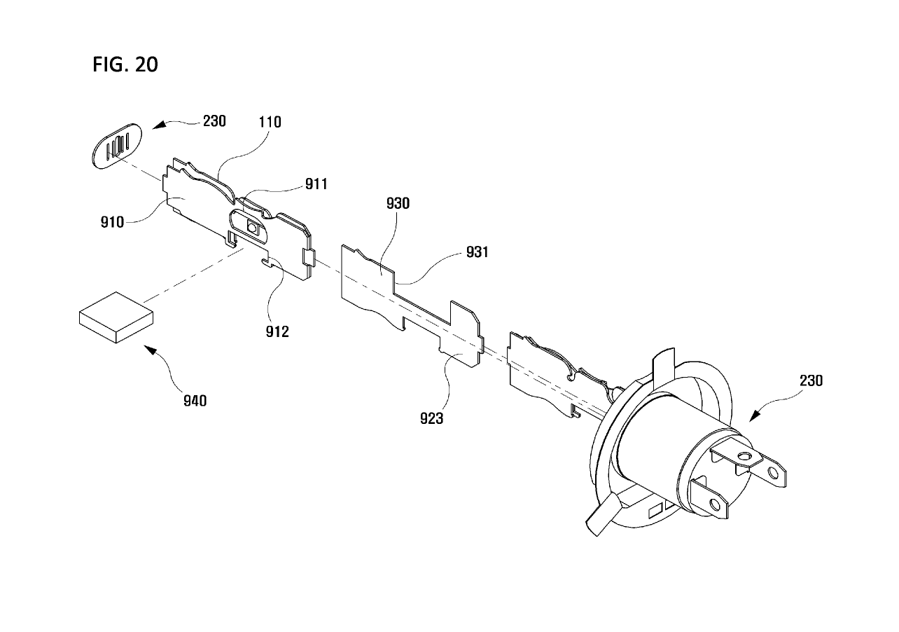

As shown in FIGS. 18 to 21C, the LED lighting apparatus according to the sixth embodiment of the present invention, a modified embodiment of the first embodiment, has a basic structure of the LED device 120 and the metallic plate 110 to which the LED device 120 is coupled. The metallic plates 110 are disposed in parallel to each other, and include a first metallic plate and a second metallic plate which have one or more LED devices 120 on opposite surfaces to facing surfaces.

The LED lighting apparatus according to the sixth embodiment of the present invention includes a pair of covering metallic plates 910 installed on the installation surface of the LED device 120, with an interval from the first and the second metallic plates such that the LED device 120 is exposed to the outside.

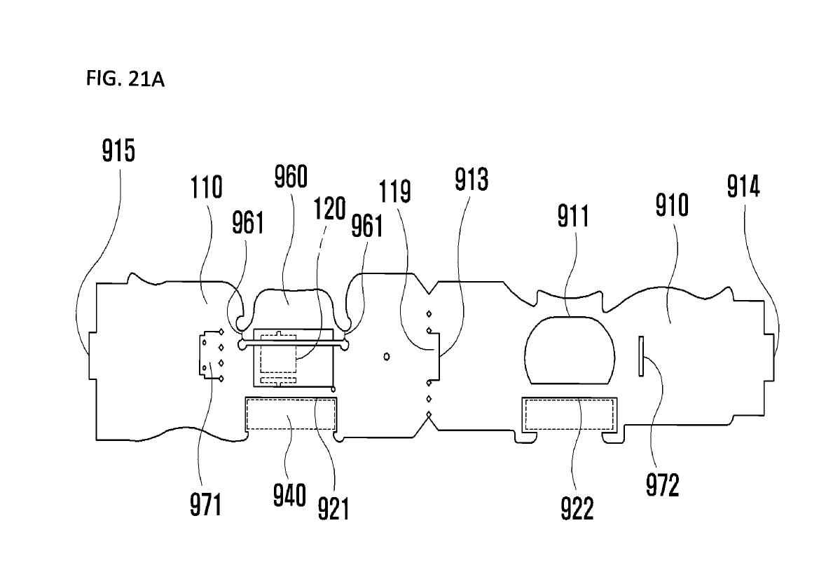

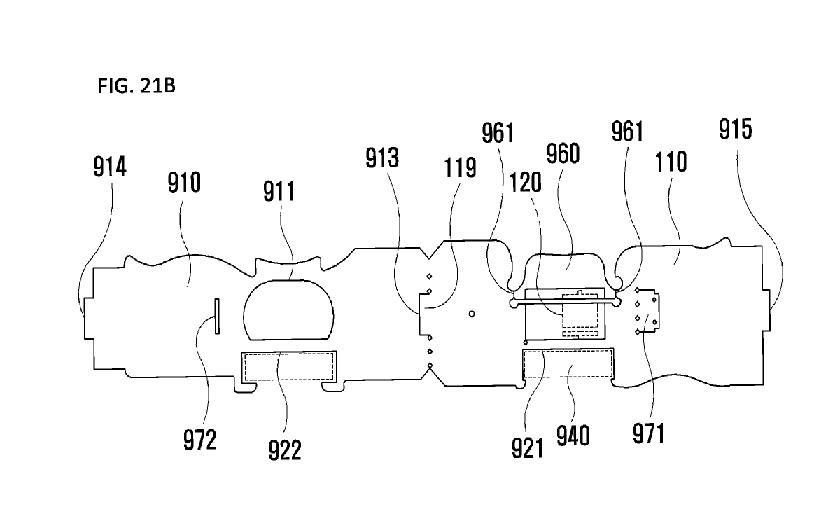

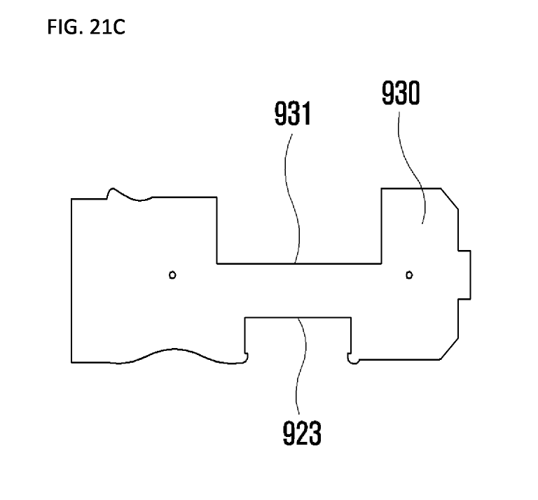

As shown in FIGS. 21A and 21C, the pair of covering metallic plates 910 may be installed on the installation surface of the LED device 120, with an interval from the first and the second metallic plates such that the LED device 120 is exposed to the outside.

Especially, the pair of covering metallic plates 910 may be provided with openings 911 through which the LED device 120 is exposed to the outside, on the installation surface of the LED device 120.

The opening 911, formed at the covering metallic plates 910 on the installation surface of the LED device 120, such that the LED device 120 is exposed to the outside therethrough, may have various structures. For instance, the opening 911 may be implemented as a cut-out groove as well as a hole.

The pair of covering metallic plates 910 are integrally connected to a front end or a rear end of the first and the second metallic plates, thereby radiating heat generated from the LED device 120 installed at each of the first and the second metallic plates.

As cutting lines 913 are formed near a boundary between the covering metallic plate 910 and the first metallic plate, and a boundary between the covering metallic plate 910 and the second metallic plate, protrusions 119 for coupling with the substrate 261 may be additionally formed.

The protrusions 119 are formed when bent at the boundary between the covering metallic plate 910 and the first metallic plate, and at the boundary between the covering metallic plate 910 and the second metallic plate.

The pair of covering metallic plates 910 may have protrusions 914 for coupling with the interval maintenance member 280, on opposite sides to connection parts to the first metallic plate and the second metallic plate. Each of the first and the second metallic plates may have a protrusion 915 for coupling with the interval maintenance member 280.

The pair of covering metallic plates 910 are integrally connected to the first and the second metallic plates, thereby more effectively radiating heat generated from the LED device 120. As a result, a light emitting characteristic of the LED device may be enhanced.

The pair of covering metallic plates 910 may have openings 972 for inserting an end of an interval maintenance unit 971 protruding from the first and the second metallic plates in a bent manner so as to maintain an interval between the first and the second metallic plates.

Since the first and the second metallic plates where the LED devices 120 have been installed are disposed to face each other, heat generated from the LED devices 120 is interacted with each other. As a result, heating effect may occur.

In order to prevent such a heating effect, an intermediate metallic plate 930 may be additionally installed between the first and the second metallic plates, in parallel to the first and the second metallic plates.

The intermediate metallic plate 930, a member installed between the first and the second metallic plates and configured to prevent heat transfer therebetween, is preferably formed of the same material as the first and the second metallic plates.

The intermediate metallic plate 930 may have a cut-out portion 931 which is partially cut-out in correspondence to part of the first and the second metallic plates where the LED devices have been installed.

For maximization of a heat radiation effect, the first metallic plate, the second metallic plate, an auxiliary metallic plate 930, and the intermediate metallic plate 930 are preferably coated with a material such as epoxy paint, in black color.

As a result of experiments, it was observed that a heat radiation effect was more enhanced when the first metallic plate, the second metallic plate, the auxiliary metallic plate 930, and the intermediate metallic plate 930 were coated with black epoxy paint.

The coating of the metallic plates with a black material may be also applicable to the first to the fifth embodiments.

The LED lighting apparatus having the aforementioned structure may further include a fan 940 for enhancing an illumination effect, since an illumination effect of the LED device 120 is lowered when heat radiation is not smoothly performed.

The fan 940, configured to cool the LED device 120 by generating air flow, is preferably installed in a direction perpendicular to a planar surface of the metallic plate 110.

The metallic plate 110, i.e., the first metallic plate, the second metallic plate, the auxiliary metallic plate 930 and the intermediate metallic plate 930 may be provided with openings 921, 922, 923 for installation of the fan 940.

The openings 921, 922, 923 formed for installation of the fan 940 may have various shapes such as a hole or a groove.

The fan 940 may be installed at a front side or a rear side of the LED device 120, in a lengthwise direction which connects a front end and a rear end of the metallic plate 110 with each other. Alternatively, as shown in FIGS. 18 to 20, the fan 940 may be installed below the LED device 120.

In the LED device according to the sixth embodiment of the present invention, an interval of the metallic plates 110 where the LED devices 120 are installed, i.e., an interval between the first metallic plate and the second metallic plate is minimized, such that the LED device 120 is disposed on a predesigned optimum position of a reflector.

The metallic plate of the LED lighting apparatus according to the first to the sixth embodiments of the present invention may be manufactured by the following methods.

Hereinafter, a method for manufacturing an LED lighting apparatus according to the present invention will be explained with taking an LED lighting apparatus according to the sixth embodiment, as an example.

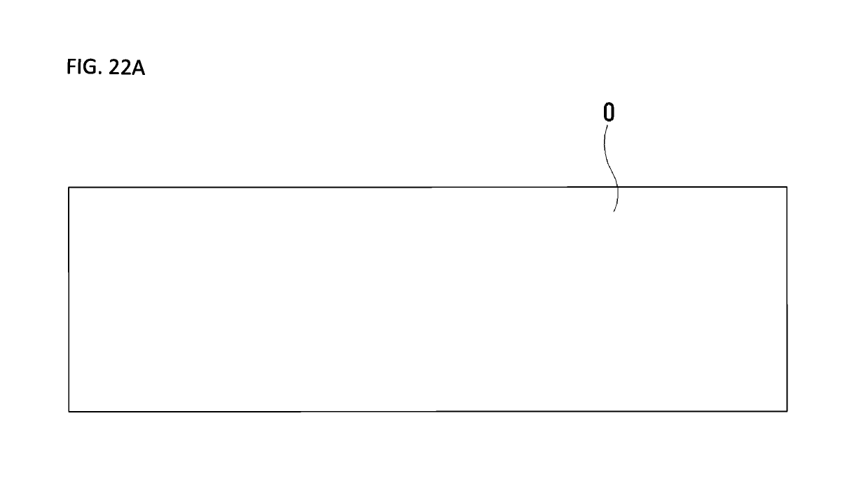

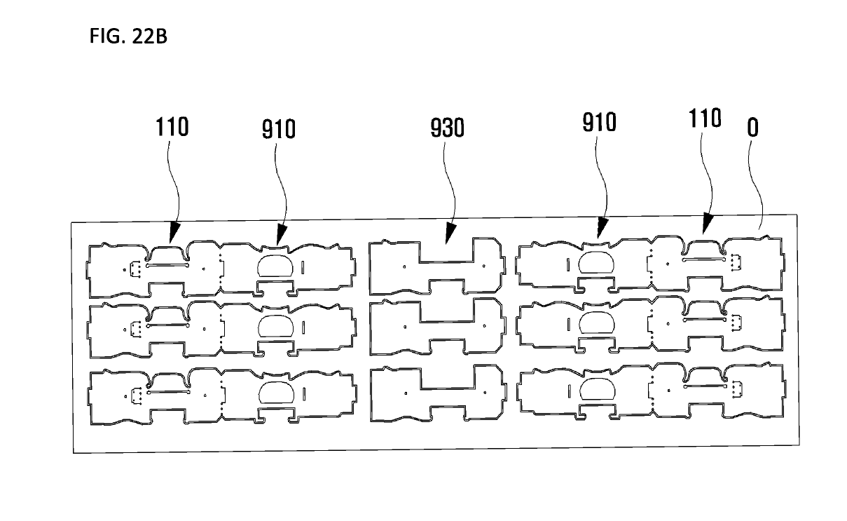

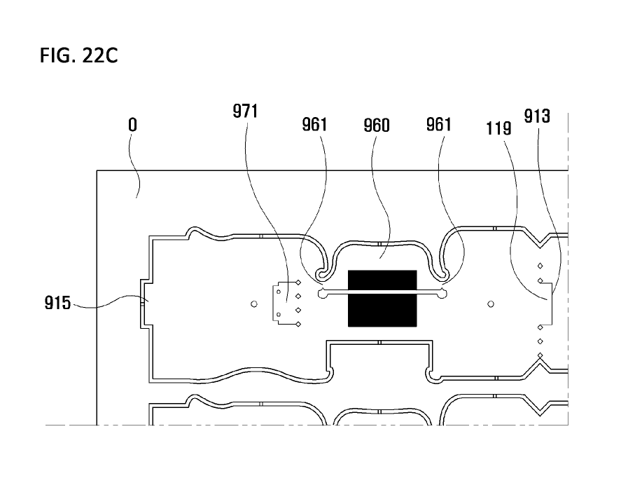

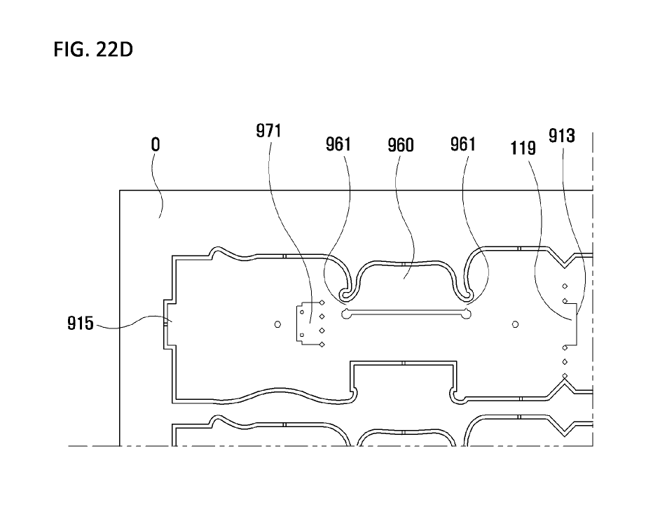

As shown in FIG. 22A, a metallic sheet (0) formed of copper or copper alloy is prepared.

As shown in FIG. 22B, an etching preventing film is formed on an upper surface and a bottom surface of the metallic sheet (0) in a state where edges of the metallic plates 110, 910, 930 formed on the metallic sheet (0) remain for implementation of shapes of the metallic plates 110, 910, 930.

In this case, for massive production, the etching preventing film is formed on the metallic sheet (0) such that the same type of metallic plates, or different types of metallic plates 110, 910, 930 are implemented.

The etching preventing film prevents the metallic plates 110, 910, 930 from being completely separated from each other by an etching process performed by a plurality of bridges 961.

The metallic plates 110, 910, 930 may be separated from each other during a subsequent process.

The etching preventing film is also coated on part corresponding to a non-contact electrode of the LED device 120 which is not coupled to the metallic plates 110, 910, 930, and on part corresponding to an auxiliary member 960 separated from the metallic plates.

In a case where the auxiliary member 960 is formed on the metallic sheet (0) together with the metallic plate 110, a soldering member is attached during a soldering member attachment process to be explained later, and then a non-contact electrode of the LED device which is not coupled to the metallic plate may be coupled to the auxiliary member 960 through an LED device coupling process.

The auxiliary member 960 is not completely separated from the metallic plate 110 by an etching process, but maintains a connected state to the metallic plate 110 by one or more bridges 961.

Once the non-contact electrode is coupled to the auxiliary member 960 by the soldering member, the non-contact electrode may be easily connected to the aforementioned power connection line 250 for connection with a terminal of another LED device or a power supply line, at the time of assembling the metallic plates separated from each other for fabrication of an LED lighting apparatus (refer to FIGS. 5 and 7).

After the etching preventing film is formed on the upper surface and the bottom surface of the metallic sheet (0), the metallic sheet (0) is immersed in an etching fluid (etchant) such as acid solution, such that part where the etching preventing film is not formed is corroded. As a result, the metallic plates 110, 910, 930 to be used are formed.

The metallic sheet (0), which has undergone the etching process, may be coated with silver, nickel, etc. after a passivation film is removed. Most preferably, the metallic sheet (0) is plated with nickel.

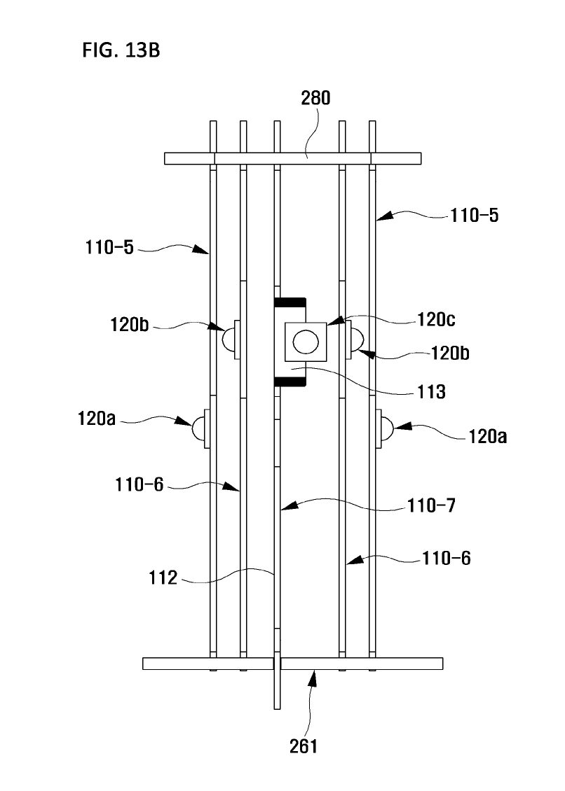

As shown in FIG. 22C, a dividing line for dividing a solder coupling region (indicated in black in FIG. 13) such that solder is coupled to a predetermined region (indicated in black in FIG. 13), a position where the LED device 120 is to be coupled, may be printed on the metallic sheet (0) which has undergone an etching process and a plating process.

A soldering member is attached onto the metallic sheet (0) which has undergone the etching process and the plating process, at a position where the LED device 120 is to be coupled.

The soldering member is attached onto the metallic sheet (0) by a laser processing apparatus. Alternatively, an opening may be formed at the metallic sheet (0), only at a position where the LED device 120 is to be coupled. Then, a soldering member mixture, formed as the soldering member such as solder is mixed with a binder in the form of powder, may be attached onto the metallic sheet (0), through the opening.

As shown in FIG. 22D, the soldering member is attached onto the metallic sheet (0), and then the LED device 120 is coupled to the metallic sheet (0). Preferably, the attachment of the soldering member and the coupling of the LED device 120 are performed, in an oven which implements heated atmosphere, such that the LED device 120 is coupled to the metallic sheet (0) by melting of the soldering member.

After the attachment of the soldering member and the coupling of the LED device 120 are performed in the oven, the metallic sheet is discharged to the outside of the oven. As a result, the LED device 120 is stably coupled to the metallic sheet by cooling.

After the LED device 120 is coupled to the metallic sheet (0), the bridge 961 is cut to separate the metallic plates 110, 910, 930 from each other. The separated metallic plates 110, 910, 930 are assembled to each other under the aforementioned structure.

For arrangement of each LED device 120 on a proper position, a jig, etc. are used.

In the above explanations, the individual metallic plates are formed on the metallic sheet by the etching process. However, various methods such as a laser processing and a press processing may be used.

In order to maximize radiation of heat from the LED device 120, hole, groove, etc. may be formed near the individual metallic plates 110, 910, 930 on the metallic sheet (0).

More preferably, hole, groove, etc. may be formed on an edge of the individual metallic plates 110, 910, 930 on the metallic sheet (0), especially, on an edge of the metallic plate where the LED device has been coupled.

A lighting apparatus may be implemented by a plurality of metallic plates formed on the metallic sheet (0) by the etching process. In this case, an LED lighting apparatus of various shapes may be implemented by bending a connection part between the metallic plates according to a pre-designed structure, in a state where the plurality of metallic plates are not separated from each other.

It was explained that the LED lighting apparatus according to the first to the sixth embodiments of the present invention is applied to an automobile. However, the LED lighting apparatus according to the first to the sixth embodiments of the present invention may be also applicable to other type of lighting apparatus such as an incandescent lamp.

That is, the LED lighting apparatus according to the first to the sixth embodiments of the present invention may be applied to a general lighting apparatus, rather than to a car.

As shown in FIGS. 5 and 6, a lighting apparatus having a basic structure that an LED device is installed on a metallic plate, may be modified in various manners.

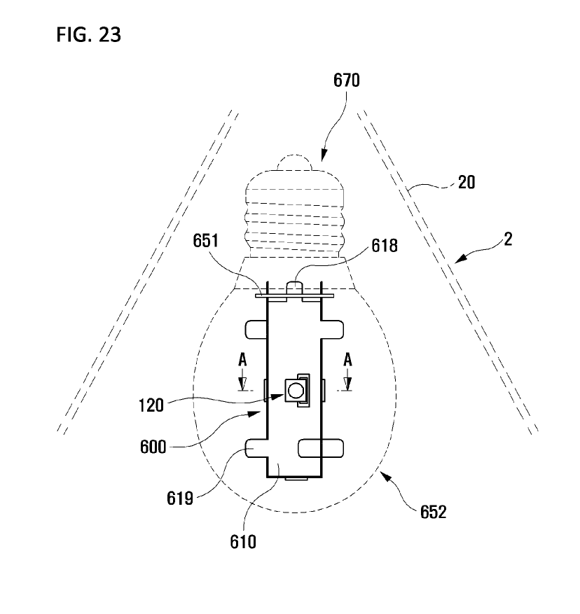

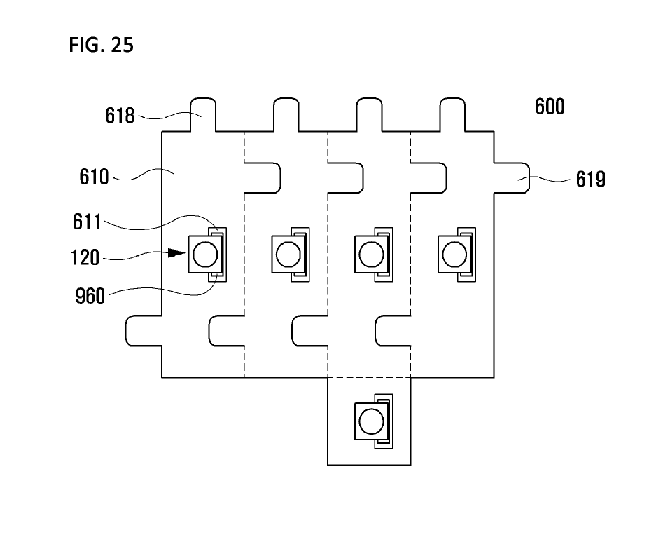

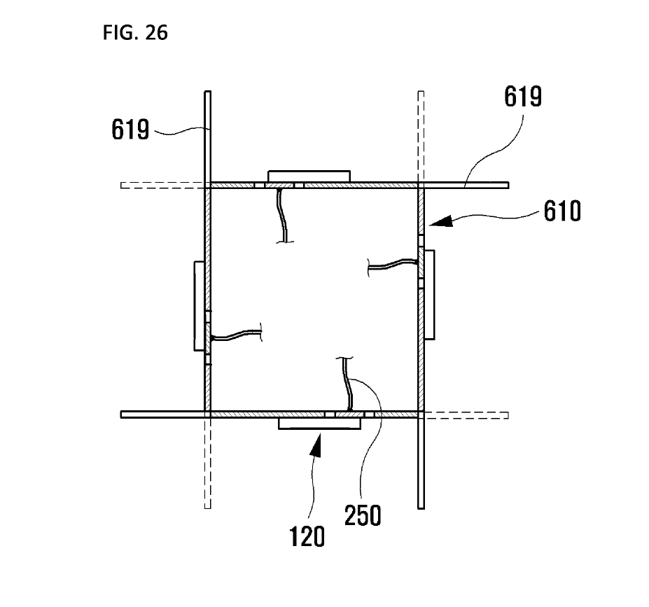

For instance, as shown in FIGS. 23 to 26, an LED lighting apparatus according to the seventh and the eighth embodiments of the present invention may include a metallic member 600 having a polyhedral structure as a metallic plate 610 of a flat surface is bent, the metallic member 600 having one or more LED devices 120 on each surface thereof.

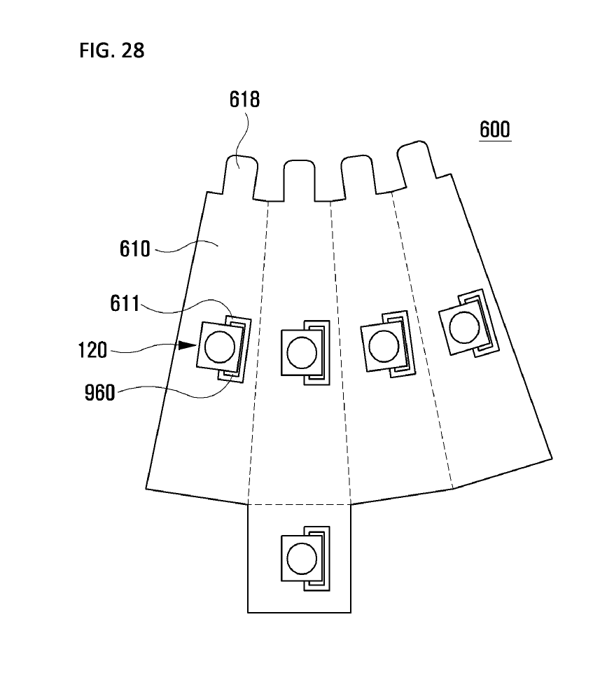

The polyhedron of the metallic member 600 may have various shapes. For instance, as shown in FIG. 23, the polyhedron of the metallic member 600 may be a rectangular parallelepiped having one surface open. Alternatively, as shown in FIG. 28, the polyhedron of the metallic member 600 may be a hexahedron having one surface open.

The metallic member 600 may be installed at a body 2, and has a polyhedral structure as the metallic plate 610 of a flat shape is bent. One or more LED devices 120 are installed on each surface of the metallic member 600.

The metallic plate 610 has a similar structure to that of the first embodiment. And a contact preventing means may be formed. More specifically, with consideration of the polyhedron of the metallic member 600, the metallic plate 610 may be provided with the contact prevention means for preventing contact of non-contact electrode such that only one electrode of the first electrode 121 and the second electrode 122 of the LED device 120 is thermally-conducted, at a preset position corresponding to the non-contact electrode which is not thermally-conducted.

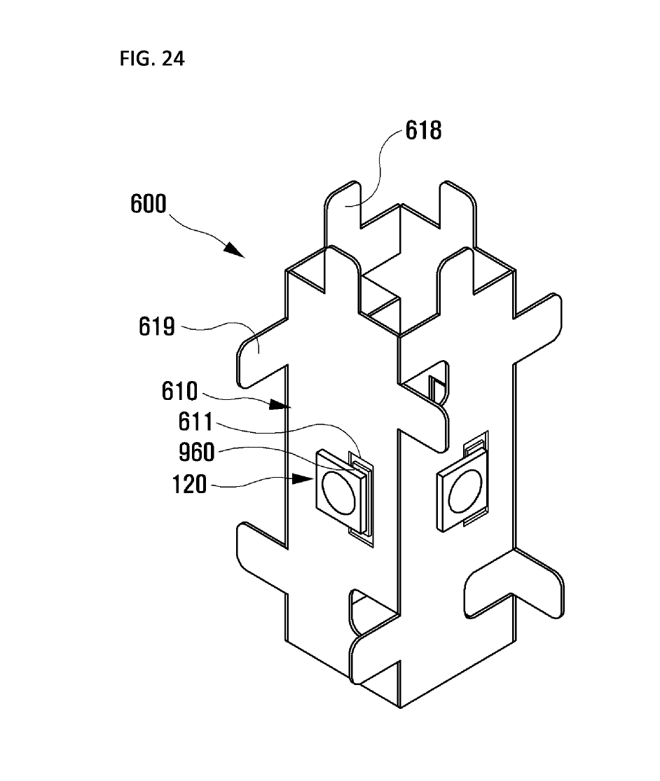

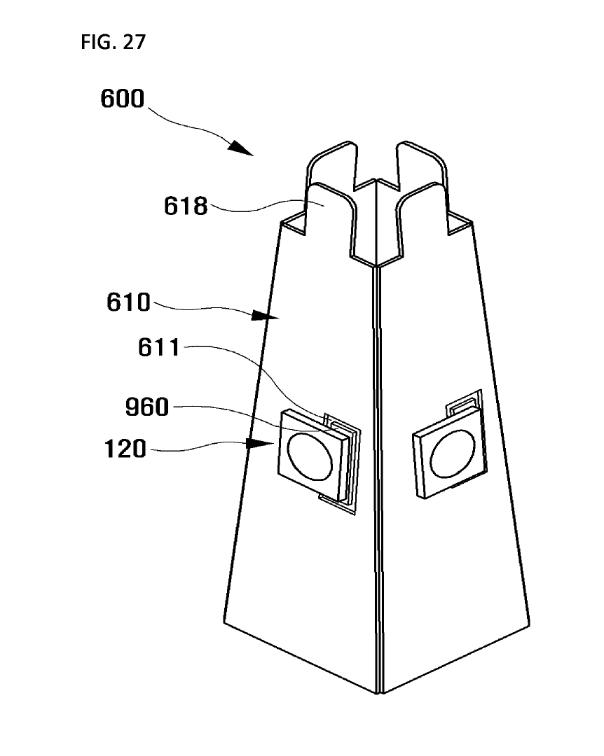

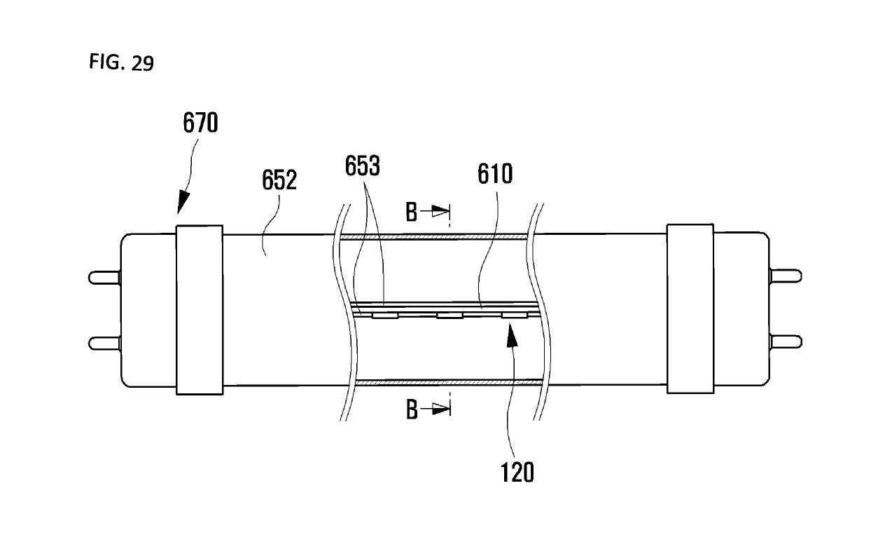

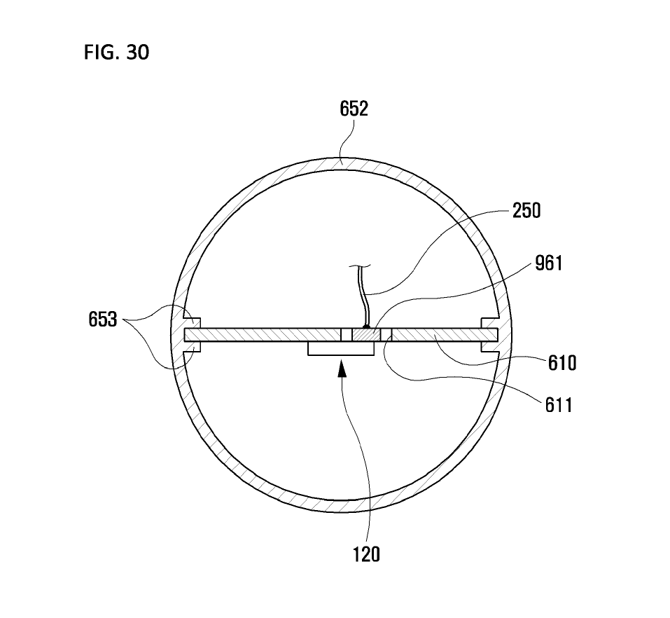

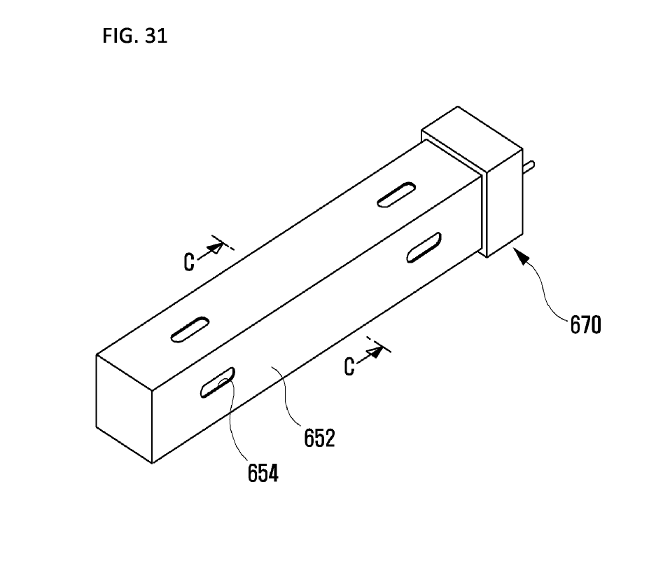

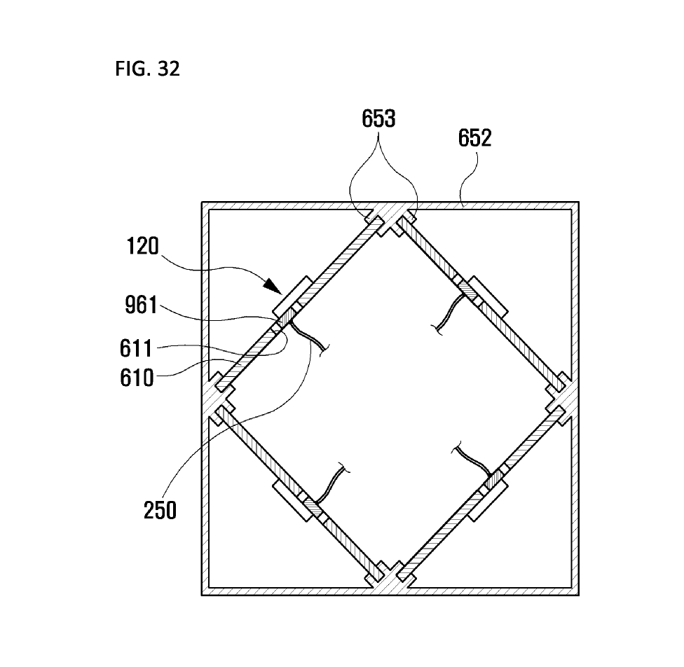

As shown in FIGS. 24 to 30, the contact preventing means may be implemented as a through hole 611 or a cut-out portion formed at the metallic plate 610.

Like in FIG. 5, the non-contact electrode may be connected to a power connection line 650 for connection with a terminal of another LED device or a power supply line, via the through hole 611.

As aforementioned, when the through hole 611, the contact preventing means is formed, the auxiliary member 960 separated from the metallic plate 610 is utilized to be connected to a power connection line 650. This can facilitate connection of the power connection line 650.

Preferably, the metallic plate 610 may be provided with cut-out portions 619 formed at bending boundaries for formation of a polyhedron.

As the cut-out portions 619 protrude to the outside when the metallic plate 610 is bent for formation of a polyhedron, a heat radiation effect when heat is radiated from the LED device 120 may be maximized.

The metallic plate 610 may further include a protrusion 618 inserted into a substrate 651 such that one end of the metallic plate 610 is fixed.

The LED lighting apparatus according to the seventh and the eighth embodiments of the present invention may include a converter circuit (not shown) configured to convert an alternating current (AC) into a direct current (DC), a stabilizing circuit (not shown) configured to stabilize a voltage, etc.

The LED lighting apparatus according to the seventh and the eighth embodiments of the present invention may also include the fan 940 according to the sixth embodiment.

An application range of the LED lighting apparatus according to the present invention may be enhanced. For instance, the LED lighting apparatus according to the present invention may be used instead of the conventional lighting apparatus adapting an incandescent lamp.

The LED lighting apparatus according to the seventh and the eighth embodiments of the present invention may have various structures and shapes according to its purpose.

More specifically, the LED lighting apparatus according to the seventh embodiment may have a similar structure to the conventional incandescent lamp.

And the LED lighting apparatus according to the eighth embodiment may have a similar structure to the conventional fluorescent lamp.

In the case where the LED lighting apparatus has a similar structure to the conventional fluorescent lamp, it was explained that a single metallic plate 610 has the LED device 120 installed toward a lower side. However, a pair of metallic plates 610 having the LED devices 120 installed toward a lower side may be implemented.

The LED lighting apparatus according to the seventh and the eighth embodiments of the present invention may include a socket unit 670 for connection with an external power as the substrate 651 where one end of the metallic plate 610 is fixed, is coupled thereto.

The socket unit 670, configured to be connected to an external power so as to supply power to the LED device 120, may have various structures according to a power connection structure.

The LED lighting apparatus according to the seventh embodiment of the present invention may further include a cover member 652 formed of a transparent or a semi-transparent material so as to diffuse light emitted from the LED device 120, or so as to protect the metallic plate 610.

As the cover member 652, any member formed of a transparent or a semi-transparent material may be used only if it is configured to diffuse light emitted from the LED device 120, or to protect the metallic plate 610.

The cover member 652 may be provided with a plurality of openings (not shown) for enhanced cooling efficiency.

The LED lighting apparatus having the above configuration has the most similar structure to the conventional incandescent lamp, thereby maximizing a utilization effect of the conventional illumination equipment.

That is, since the LED lighting apparatus of the present invention emits light in a similar manner to an incandescent lamp, a reflector optimized when an incandescent lamp is installed is utilized to the maximum. Accordingly, an illumination effect may be maximized when compared to a case where the same number of LED devices is used.

In the LED lighting apparatus of the present invention, unlike in the seventh and the eighth embodiments, the metallic plate 610 may be supported in the cover member 652 without being bent.

That is, the LED lighting apparatus according to the ninth and the tenth embodiments of the present invention includes a socket unit 670 for connection with an external power; a cover member 652 coupled to the socket unit 670, and having an inner space; and a plurality of metallic members 610 supported by the cover member 652 and installed at the inner space.

The LED lighting apparatus according to the ninth and the tenth embodiments of the present invention may have a tubular structure such as the conventional fluorescent lamp structure.

The socket unit 670 for connection with an external power may have various configurations.

The cover member 652 may have various configurations. For instance, the cover member 652 may be formed of a transparent or a semi-transparent material so as to diffuse light emitted from the LED device 120, or so as to protect the metallic plates 610.

The cover member 652 may be utilized as a support member for protecting and supporting the metallic plates 610.

More specifically, the cover member 652 may be provided with an insertion unit 353 for inserting part of an edge of the metallic plates 610, thereby supporting the metallic plates 610.

The insertion unit 353 may have any structure if it supports the metallic plates 610 by inserting part of the edge of the metallic plates 610 thereinto.

The cover member 652 may have various structures according to a structure of the LED lighting apparatus, and preferably has a tubular structure. The LED lighting apparatus may have a similar structure to a fluorescent lamp.

The LED lighting apparatus according to the ninth embodiment of the present invention has a tubular structure where a single metallic plate 610 has the LED device 120 installed toward a lower side. However, a pair of metallic plates 610 having the LED devices 120 installed toward a lower side may be implemented.

In a case where the LED lighting apparatus has a similar structure to a fluorescent lamp, socket units 670 may be installed at two ends of the LED lighting apparatus, in addition to the tubular structure of the LED lighting apparatus.

The cover member 652 may have any configuration if it is formed of a transparent or a semi-transparent material to diffuse light emitted from the LED device 120, or to protect the metallic plates 610.

The cover member 652 may be provided with a plurality of openings 654 for enhanced cooling efficiency.

The metallic plates 610 according to this embodiment have a similar configuration to those according to the seventh and the ninth embodiments, except that they are not bent. Thus, detailed explanations thereof will be omitted.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

1. An LED lighting apparatus, comprising:
one or more metallic plates; and
one or more LED devices installed on a surface of the metallic plates,
wherein only one electrode of a first electrode and a second electrode of the LED device is coupled to the metallic plates.

2. The LED lighting apparatus of claim 1, wherein the LED device is mounted to a printed circuit board coupled to the metallic plate, and one electrode of a first electrode and a second electrode of the printed circuit board is coupled to the metallic plates.

3. The LED lighting apparatus of claim 1, wherein a socket unit for coupling with a structure where the LED lighting apparatus is to be installed is coupled to one end of the pair of metallic plates.

4. The LED lighting apparatus of claim 1, wherein the metallic plate includes a plurality of metallic plates arranged such that their surfaces where the LED device is installed are partially inclined from each other.

5. An LED lighting apparatus, comprising:
a socket unit for coupling with a structure where the LED lighting apparatus is to be installed;
a pair of first metallic plates having one end coupled to the socket unit, and having first LED devices on opposite surfaces to facing surfaces;
a pair of second metallic plates disposed between the pair of first metallic plates in parallel to the pair of first metallic plates, having one end coupled to the socket unit, and having second LED devices on opposite surfaces to facing surfaces;
one or more third metallic plates disposed between the pair of second metallic plates in parallel to the pair of second metallic plates, having one end coupled to the socket unit, having a bent portion bent so as to be perpendicular to the second metallic plates, and having a third LED device on the bent portion; and
an interval maintenance member coupled to another end of the first to the third metallic plates, and configured to maintain intervals among the first to the third metallic plates.

6. The LED lighting apparatus of claim 2, wherein the metallic plate includes a plurality of metallic plates arranged such that their surfaces where the LED device is installed are partially inclined from each other.

7. The LED lighting apparatus of claim 3, wherein the metallic plate includes a plurality of metallic plates arranged such that their surfaces where the LED device is installed are partially inclined from each other.
